(19) United States
(12) Patent Application Publication
(10) Pub. No.: US 2001/0044518 A1
(43) Pub. Date: Nov. 22, 2001

(54) Dust-free, epoxy-containing stabilizer granules and the preparation process

(76) Inventors: Kurt Hoffmann, Wachenheim (DE); Heinz Herbst, Heppenheim (DE); Rudolf Pfaendner, Rimbach (DE)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 09/879,422

(22) Filed: Jun. 12, 2001

Related U.S. Application Data
(62) Division of application No. 09/160,000, filed on Sep. 24, 1998.

(30) Foreign Application Priority Data
Sep. 29, 1997 (EP) 97810712.6

(51) Int. Cl. C08G 59/40

(52) U.S. Cl. 528/108

(57) ABSTRACT

The invention relates to low-dust granules of plastics additives, comprising

a) a phenolic antioxidant, an organic phosphite or phosphonite, a phosphonate, a sterically hindered amine or a UV absorber, individually, or a mixture of these compounds, and

b) at least one epoxy compound which is solid at room temperature.

The granules are particularly suitable for stabilizing polymers, especially polyolefins such as polypropylene or polyethylene.

The present invention relates to low-dust granules of plastics additives (stabilizers) which comprise solid epoxides, to a process for preparing these granules and to the use of these granules for stabilizing polymers.

Organic polymers (plastics), especially polyolefins, generally require the addition of additives in order to enable them to be processed and in order that the service properties are retained over the period of utilization. Harm is caused to organic polymers not only by light and heat but also by remnants of the catalysts used in the preparation. Prior art additives and stabilizers that can be used encompass a very wide variety of classes of substance. Owing to the diverse processes, not always known in detail, of damage to organic polymers, it is common to employ mixtures of two or more additives.

In general, the additives are in powder form. Additive mixtures in powder form, however, have a range of disadvantages, such as dust production through to dust explosion, a separation tendency, and metering difficulties. As a result, commercial forms are sought which do not have these disadvantages. Processes described for this purpose include, for example, agglomeration techniques (aqueous and with or without a dispersant), mixing techniques with binder, or compacting with a pellet press. The commercial forms obtainable in this way, however, still in the majority of cases to date lack adequate mechanical properties. In many cases, the commercial forms still include water or binders, which in the course of subsequent incorporation into an organic polymer may cause disruptions or necessitates special measures.

There is therefore a desire for granular, storage-stable additive mixtures which comprise no binders which impair the polymer into which they are incorporated. Granules of this kind are also desirable from the increasingly important environmental standpoint (low dust load, sparing use of material).

Surprisingly, plastics additive granules which go a long way towards satisfying the requirements of the art are obtained by heating individual plastics additives or a mixture of plastics additives and at least one polyfunctional epoxy compound which is solid at room temperature to a point such that the epoxy compound has substantially melted and yet the temperature is not yet high enough for a crosslinking reaction of the epoxy groups and it is possible to carry out the subsequent operation of shaping in the plastic state.

The plastics additive granules of the invention are very uniform and feature excellent bulk product properties, especially dust paucity, free flow and resistance to abrasion, and also good stability on storage. They lend themselves very well to metered addition to the organic polymers that are to be stabilized, and have a more favourable homogenization and incorporation behaviour than the conventional powder mixtures.

Epoxy-containing compositions are able in addition to improve the long-term properties and/or service properties of polymers, especially recycled polymers or filled systems. WO 94/29377 provides examples of this.

It has surprisingly been found that the low-dust granules prepared in accordance with the invention lead to a further improvement in the impact strength following thermal exposure, in comparison to a purely physical mixture of the individual components.

The invention provides low-dust granules of plastics additives, comprising

a) a phenolic antioxidant, an organic phosphite or phosphonite, a phosphonate, a sterically hindered amine or a UV absorber, individually, or a mixture of these compounds, and

b) at least one epoxy compound which is solid at room temperature.

In the context of the present invention low-dust granules mean granules whose dust emission in the Heubach test is less than 0.15% by weight (after 5 minutes).

Preference is given to granules comprising a polyfunctional epoxide as component b).

In one preferred embodiment the granules of the invention consist to the extent of at least 10-90% by weight, with particular preference at least 20-80% by weight and, with very particular preference, 50-80% by weight of an epoxy compound.

Preferred solid polyfunctional epoxides are compounds having a softening point of 40-150° C. A minor proportion of liquid epoxides may be present as an admixture in these solid epoxides. Provided that only small amounts are added, there is no adverse effect on the free flow and granulatability of the mixture.

The particle size distribution of the granules of the invention, as defined in accordance with ISO 3435, lies preferably between 1 mm and 6 mm, with particular preference between 2 mm and 6 mm.

The loose bulk density is preferably greater than 500 g/l, the loose bulk density depending on the density of the overall mixture and possibly being higher or lower in mixtures whose density differs greatly from that of the epoxide. The levels indicated therefore relate to mixtures for which the density differs by no more than 10% from that of the epoxide. For greater differences in the density of the mixture, the loose bulk density must be corrected by the factor obtained from the ratio of the density of epoxide to the density of the mixture.

The free flow is determined in accordance with DIN 53492 and is preferably less than 15 s (tR15) and, with particular preference, less than 10 s (tR15).

As mentioned above the dust emission is determined by means of the Heubach test in an industry-typical test setup in which the test material is held in motion to permit the propensity towards abrasion dusting to be detected as well. The apparatus used is produced by the company Heubach Engineering GmbH, Langelsheim, DE. In detail, the test material (initial mass 50 g) is agitated at 30 rpm (corresponding to a peripheral speed of 19 cm/s) for 5 minutes in a dust production device with a capacity of 2.5 l, in which three chicanes are arranged at an angle of 45° to the housing wall in the direction of rotation, while an airflow of 0.32 l/s deposits the fine fraction on a filter. The fine fraction thus determined preferably does not amount to more than 0.1% by weight.

Further suitable plastics additives that may be present in the granules include compounds from the group of the hydrotalcites, metal oxides, metal carbonates, metal soaps, such as calcium stearate, antistats, antiblocking agents, flame retardants, thioesters, internal and external lubricants, processing aids and pigments.

The granules may also include additional substances, such as thermoplastic polymers (for example, polyolefins or polyolefin waxes).

These further plastics additives which may be present in the granules are known both per se and in various combinations. Many of the plastics additives described below are obtainable commercially. The other plastics additives can be prepared by known processes and under standard conditions are in the form of solids (powders or granules, for example), melts (for example, direct from the synthesis stage), or liquids.

The invention additionally provides a process for preparing plastics additive granules, which comprises heating

a) a phenolic antioxidant, an organic phosphite or phosphonite, a phosphonate, a sterically hindered amine or a UV absorber, individually, or a mixture of these compounds, and

b) at least one epoxy compound which is solid at room temperature

to an extent such that at least 80% by weight of the epoxy compound has melted, pressing the melt through a plate provided with dies or perforations, the die or perforation diameter being between 1 and 10 mm, and chopping the resulting strands in the plastic state to form granules.

The temperature before the outlet die (at the die head) is preferably between 60-160° C., with particular preference 80-120° C.

The die or perforation diameter is preferably between 2 and 6 mm.

Preferably, the plastics additives and the epoxy compound are melted in a single-screw or twin-screw extruder; such extruders are known in the plastics processing industry and are sold, for example, by the companies Buss (CH), Brabender (DE), Werner & Pfleiderer (DE) or Bühler (CH). In this case the plastics additives are generally employed as solids (e.g. powders or granules), or their melts, aqueous suspensions or, in minor amounts, liquid additives may also be employed. Following or even during the chopping of the extruded strands, which takes place in the still soft state, following their passage through a die or perforated plate, the granular particles are cooled. Cooling can take place in the form of wet cooling with water (for example in water, through a water film or water ring, etc.) or, preferably, with air (for example, air-film, air-vortex, etc.) or else by a combination of cooling techniques. In the case of cooling with water, a subsequent dewatering and drying (preferably in a vortex dryer or fluidized-bed dryer) is required. These cooling techniques and their technical embodiments are known. The key feature is that granulation takes place in the plastic state prior to the actual cooling step, in contradistinction to the strand pelletizing and grinding processes common in the art.

In the preparation of the epoxy/plastics additive melt it is common not to operate at a single constant temperature; instead, the mass passes through a temperature profile in a continuous process. In such a profile it is judicious not to exceed a peak temperature of 160° C. These temperatures refer to the temperature of the mass.

Preference extends to a process in which degassing is employed as well. In the conduct of the process, this degassing facility is preferably accommodated in a region in which the epoxy compound is melted or in a downstream region.

The plastics additive granules obtainable by the process described are also provided by the present invention. The preferences described apply analogously to the granules.

A particularly preferred embodiment of the invention is the combination of 30-80% by weight of epoxy compound with 5-25% by weight of an antioxidant of the sterically hindered phenol type, 5-25% by weight of a phosphite or phosphonite, 10-40% by weight of CaO and 1 to 5% by weight of calcium stearate.

The epoxy compound in this granular mixture is, with particular preference, an epoxide based on bisphenol A diglycidyl ether.

Particular preference is also given to the combination of 50-80% by weight of epoxy compound with 50-20% by weight of a phosphonate.

The antioxidants of the sterically hindered phenol type are widely known as antioxidants for organic materials and are frequently used to stabilize polymers. These compounds preferably include at least one group of the formula (X)

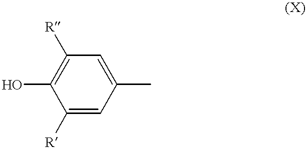

in which R′ is hydrogen, methyl or tert-butyl and R″ is unsubstituted or substituted alkyl or substituted alkylthioalkyl.

Particular preference is given to compounds which include at least one group of the formula

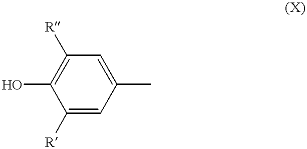

in which R′ is methyl or tert-butyl and R″ is unsubstituted or substituted alkyl or substituted alkylthioalkyl.

Examples of such phenolic antioxidants are:

1. Alkylated monophenols, for example 2,6-di-tert-butyl-4-methylphenol, 2-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, 2,6-di-nonyl-4-methylphenol, 2,4-dimethyl-6-(1′-methylundec-1′-yl)-phenol, 2,4-dimethyl-6-(1′-methylheptadec-1′-yl)-phenol, 2,4-dimethyl-6-(1′-methyl-tridec-1′-yl)phenol and mixtures thereof.

2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-didodecyl-thiomethyl-4-nonylphenol.

3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

4. Tocopherols, for example α-tocopherol, β-tocopherol, γ-tocopherol, δ-tocopherol and mixtures thereof (vitamin E).

5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl] terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.

7. O- N- and S-benzyl compounds, for example 3,5,3′,5′-tetra-tert-butyl-4,4′-dihydroxydibenzyl ether, octadecyl 4-hydroxy-3,5-dimethylbenzylmercaptoacetate, tris(3,5-di-tert-butyl-4-hydroxybenzyl)-amine, bis(4-tert-butyl-3-hydroxy-2,6-dimethylbenzyl) dithioterephthalate, bis(3,5-di-tert-butyl-4-hydroxybenzyl) sulfide, isooctyl 3,5-di-tert-butyl-4-hydroxybenzylmercaptoacetate.

8. Hydroxybenzylated malonates, for example dioctadecyl 2,2-bis(3,5-di-tert-butyl-2-hydroxybenzyl)malonate, dioctadecyl 2-(3-tert-butyl-4-hydroxy-5-methylbenzyl)malonate, didodecyl mercaptoethyl-2,2-bis(3,5-di-tert-butyl-4-hydroxybenzyl)malonate, di-[4-(1,1,3,3-tetramethylbutyl)phenyl] 2,2-bis(3,5-di-tert-butyl-4-hydroxybenzyl)malonate.

9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

10. Triazine compounds, for example 2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl) isocyanurate.

11. Acylaminophenols, for example 4-hydroxylauranilide, 4-hydroxystearanilide, octyl N-(3,5-di-tert-butyl-4-hydroxyphenyl)carbamate.

12. Esters of β-(3,5-di-tert-butyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

13. Esters of β-(5-tert-butyl-4-hydroxy-3-methylphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

14. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)-oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

15. Esters of 3,5-di-tert-butyl-4-hydroxyphenylacetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis-(hydroxyethyl)-oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

16. Amides of β-(3,5-di-tert-butyl-4-hydroxyphenyl)propionic acid e.g. N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenyl-propionyl)hydrazine.

Preference is given to the antioxidants listed above in sections 7, 9, 10, 12, 13, 14 and 16, especially section 7, 9, 10 and 12.

Further particularly preferred compounds are:

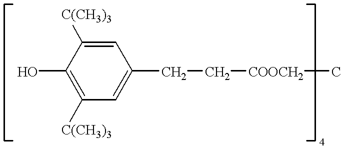

β-(3,5-di-tert-butyl-4-hydroxyphenyl)propionic ester of pentaerythritol

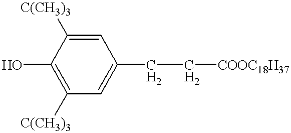

octadecyl β-(3,5-di-tert-butyl-4-hydroxyphenyl)propionate

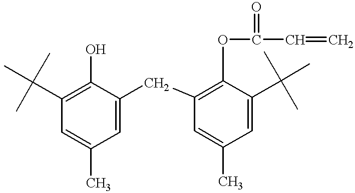

2-(1,1-dimethylethyl)-6-[[3-(1,1-dimethylethyl)-2-hydroxy-5-methylphenyl]methyl]-4-methylphenyl 2-propenoate;

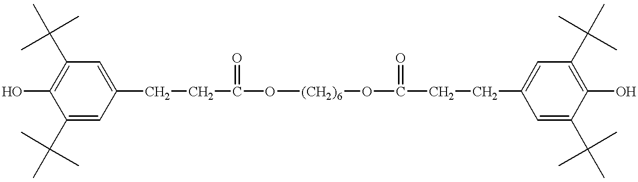

1,6-hexanediyl 3,5-bis(1,1-dimethylethyl)-4-hydroxyphenylpropanoate;

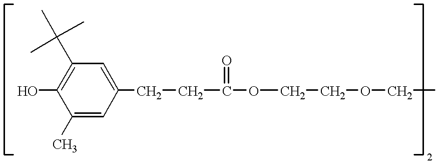

1,2-ethanediylbis(oxy-2,1-ethanediyl) 3-(1,1-dimethylethyl)-4-hydroxy-5-methyl-phenylpropanoate;

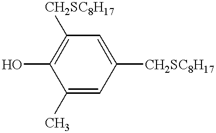

{2-methyl-4,6-bis[(octylthio)methyl]phenol};

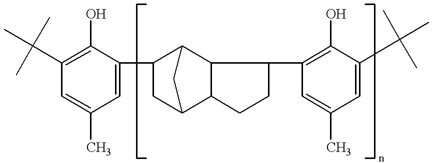

butylated reaction product of para-cresol and dicyclopentadiene (average molecular weight 600-700)

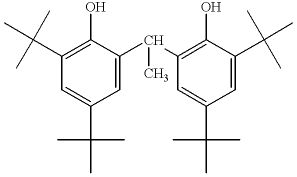

2,2′-ethylidene-bis-(4,6-di-tert-butylphenol);

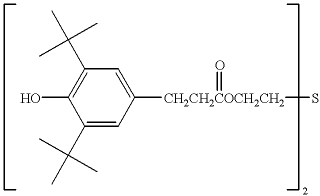

thiodi-2,1-ethanediyl 3,5-bis(1,1-dimethylethyl)-4-hydroxyphenylpropanoate;

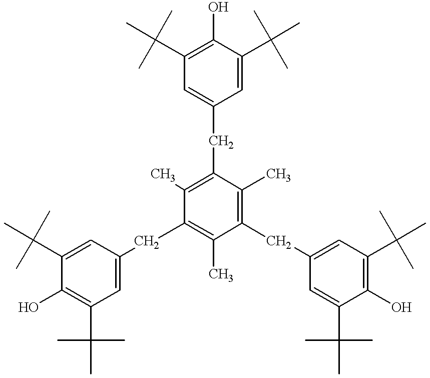

4,4′,4″-[(2,4,6-trimethyl-1,3,5-phenyltriyl)tris(methylene)]tris[2,6-bis(1,1-dimethylethyl)-phenol];

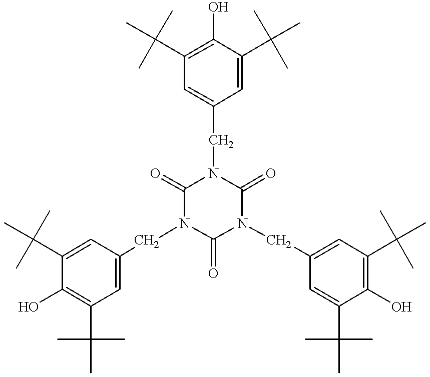

1,3,5-tris[[3,5-bis(1,1-dimethylethyl)-4-hydroxyphenyl]methyl]-1,3,5-triazine-2,4,6(1H,3H,5H)-trione.

The amount of the antioxidants of the sterically hindered phenol type depends on the intended use of the plastics additive granules; judiciously, the granules comprise 0-90% by weight, preferably 3-60% by weight of antioxidant of the sterically hindered phenol type.

Examples of phosphonates are those of the formula I

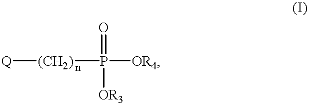

in which

R₃ is H, C₁-C₂₀alkyl, unsubstituted or C₁-C₄alkyl-substituted phenyl or naphthyl,

R₄ is hydrogen, C₁-C₂₀alkyl, unsubstituted or C₁-C₄alkyl-substituted phenyl or naphthyl; or is

M^{r+}/r,

M^{r+} is an r-valent metal cation or the ammonium ion,

n is 0, 1, 2, 3, 4, 5 or 6, and

r is 1, 2, 3 or 4;

Q is hydrogen, —X—C(O)—OR₇, or a radical

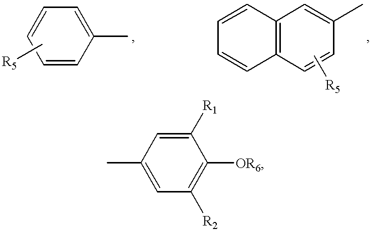

R₁ is isopropyl, tert-butyl or cyclohexyl or is cyclohexyl substituted by 1-3 C₁-C₄alkyl groups,

R₂ is hydrogen, C₁-C₄alkyl or cyclohexyl or is cyclohexyl substituted by 1-3 C₁-C₄alkyl groups,

R₅ is H, C₁-C₁₈alkyl, OH, halogen or C₃-C₇cycloalkyl;

R₆ is H, methyl, trimethylsilyl, benzyl, phenyl, sulfonyl or C₁-C₁₈alkyl;

R₇ is H, C₁-C₁₀alkyl or C₃-C₇cycloalkyl; and

X is phenylene, phenylene substituted by C₁-C₄alkyl groups, or cyclohexylene.

Preference is given to sterically hindered hydroxyphenyl-alkyl-phosphonic esters and monoesters as are known, for example, from U.S. Pat. No. 4,778,840.

Particular preference is given to compounds of the formula Ia

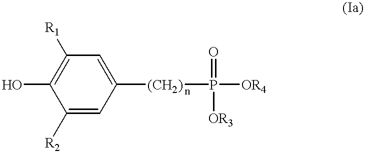

in which

R₁ is H, isopropyl, tert-butyl or cyclohexyl or is cyclohexyl substituted by 1-3 C₁-C₄alkyl groups,

R₂ is hydrogen, C₁-C₄alkyl or cyclohexyl or is cyclohexyl substituted by 1-3 C₁-C₄alkyl groups,

R₃ is C₁-C₂₀alkyl, unsubstituted or C₁-C₄alkyl-substituted phenyl or naphthyl,

R₄ is hydrogen, C₁-C₂₀alkyl, unsubstituted or C₁-C₄alkyl-substituted phenyl or naphthyl; or is

M^{r+}/r,

M^{r+} is an r-valent metal cation,

n is 1, 2, 3, 4, 5 or 6, and

r is 1, 2, 3 or 4.

Halogen is fluorine, chlorine, bromine or iodine.

Suitable alkyl substituents having up to 18 carbon atoms are the radicals such as methyl, ethyl, propyl, butyl, pentyl, hexyl and octyl, stearyl and also corresponding branched isomers, preferably C₂-C₄alkyl.

Examples of C₁-C₄alkyl-substituted phenyl or naphthyl, containing preferably 1 to 3, especially 1 or 2 alkyl groups, are o-, m- and p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl, 2,6-diethylphenyl, 1-methylnaphthyl, 2-methylnaphthyl, 4-methylnaphthyl, 1,6-dimethylnaphthyl and 4-tert-butylnaphthyl.

Examples of C₁-C₄alkyl-substituted cyclohexyl, containing preferably 1 to 3, especially 1 or 2 branched or unbranched alkyl group radicals, are cyclopentyl, methylcyclopentyl, dimethyl-cyclopentyl, cyclohexyl, methylcyclohexyl, dimethylcyclohexyl, trimethylcyclohexyl and tert-butylcyclohexyl.

A mono-, di-, tri- or tetravalent metal cation is preferably an alkali metal, alkaline earth metal, heavy metal or aluminium cation, examples being Na⁺, K⁺, Mg⁺⁺, Ca⁺⁺, Ba⁺⁺, Zn⁺⁺, Al⁺⁺⁺, and Ti⁺⁺⁺⁺. Ca⁺⁺ is especially preferred.

Preferred compounds of the formula I are those having at least one tert-butyl group as a radical R₁ or R₂. Very particular preference is given to compounds wherein R₁ and R₂ are both tert-butyl.

n is preferably 1 or 2 and very preferably 1.

Preference is likewise given to the compounds of the formulae II, III, IV, V and VI

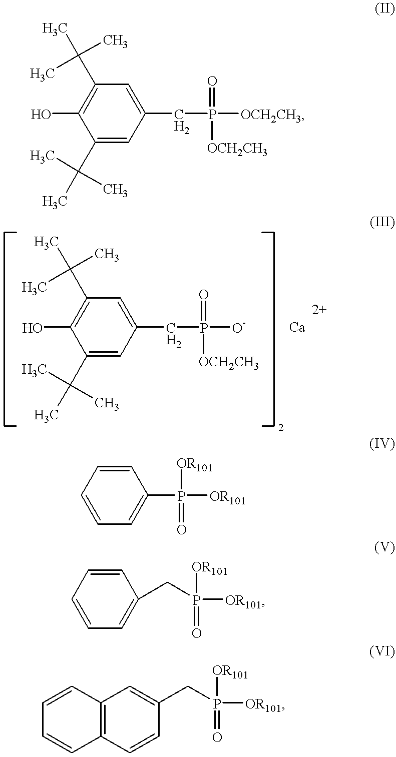

in which each R₁₀₁ independently of the others is hydrogen or M^{r+}/r. Definitions of M^{r+}/r have already been given above.

The compound of the formula II is available commercially under the name Irganox®1222 (Ciba Spezialitätenchemie) and those of the formula III under the name lrganox®1425 (Ciba Spezialitätenchemie).

The compounds IV, V and VI are in some cases obtainable commercially or can be prepared by standard techniques.

Particularly preferred phosphonates are dimethyl 2,5-di-tert-butyl-4-hydroxybenzyl-phosphonate, diethyl 3,5-di-tert-butyl-4-hydroxybenzylphosphonate, dioctadecyl 3,5-di-tert-butyl-4-hydroxybenzylphosphonate, dioctadecyl-5-tert-butyl-4-hydroxy-3-methylbenzyl-phosphonate and the calcium salt of 3,5-di-tert-butyl-4-hydroxybenzylphosphonic acid monoethyl ester. Very particular preference is given to diethyl 3,5-di-tert-butyl-4-hydroxy-benzylphosphonate.

The organic phosphites and phosphonites are likewise known as stabilizers for plastics. They are used in particular as processing stabilizers for polyolefins.

The products involved are predominantly aromatic phosphites and phosphonites. Examples thereof are triphenyl phosphite, diphenyl alkyl phosphites, phenyl dialkyl phosphites, tris(diphenylalkylphosphito)amines, tris(nonylphenyl) phosphite, trilauryl phosphite, trioctadecyl phosphite, distearyl pentaerythrityl diphosphite, tris(2,4-di-tert-butylphenyl) phosphite, bis(2,4-di-tert-butylphenyl) pentaerythrityl diphosphite, tristearyl sorbityl tri-phosphite, tetrakis(2,4-di-tert-butylphenyl) 4,4′-biphenylenediphosphonite, 3,9-bis(2,4-di-tert-butyl-4-methylphenoxy)-2,4,8,10-tetraoxa-3,9-diphosphaspiro[5.5]undecane, 3,9-tris(2,4,6-tris-tert-butylphenoxy)-2,4,8,10-tetraoxa-3,9-diphosphaspiro[5.5]undecane, 2,4,6-tris-tert-butylphenyl 2-butyl-2-ethyl-1,3-propanediyl phosphite and 2,2′-ethylidenebis(4,6-di-tert-butylphenyl) fluorophosphite.

The following phosphites are used with particular preference:

tris(2,4-di-tert-butylphenyl) phosphite,

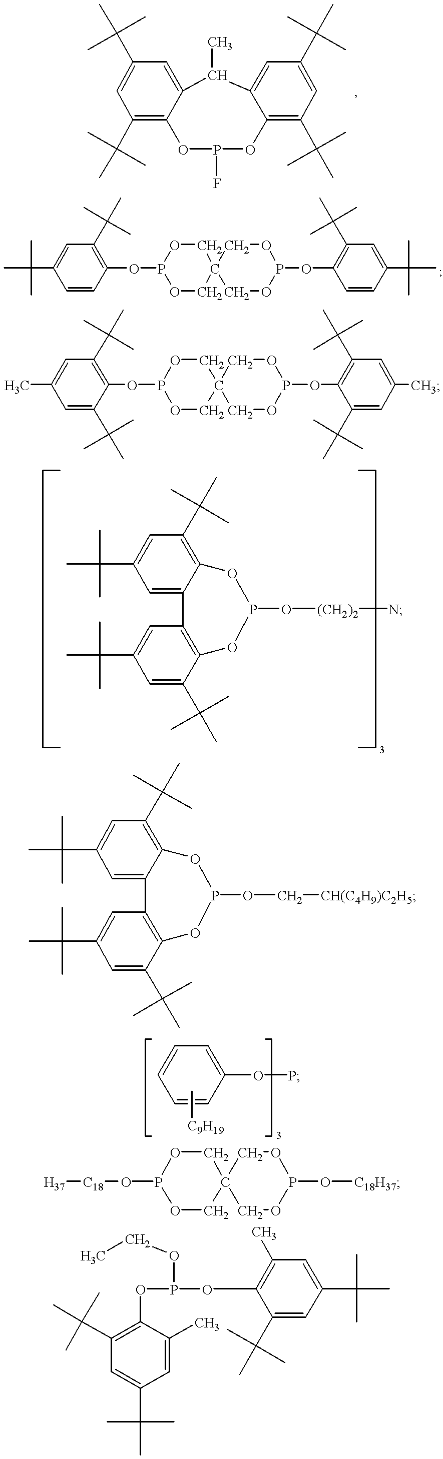

With very particular preference, tris(2,4-di-tert-butylphenyl) phosphite is used.

The amount of the phosphites or phosphonites depends on the intended use of the plastics additive granules; judiciously, the granules comprise 0-90% by weight, preferably 3-70% by weight, of phosphite or phosphonite.

Preferably, in addition to a sterically hindered phenol, the additive granules also include an organic phosphite and/or phosphonite. In that case, the weight ratio of sterically hindered phenol to phosphite and/or phosphonite is preferably from 20:1 to 1:20, particular preference being given to a ratio of from 10:1 to 1:10 and very particular preference to a ratio of 4:1-1:4.

Of particular interest are compositions comprising at least one compound of the group of the sterically hindered amines, of the class of compounds described under (a′) to (g′), which comprise at least one radical of the formula XII or XIII.

(a′) Compounds of the formula XIIa

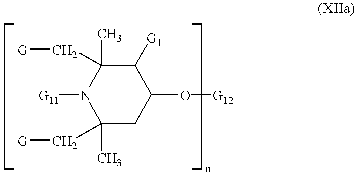

in which n is a number from 1 to 4,

G and G₁ independently of one another are hydrogen or methyl,

G₁₁ is hydrogen, O′, hydroxyl, NO, —CH₂CN, C₁-C₁₈alkyl, C₃-C₈alkenyl, C₃-C₈alkynyl, C₇-C₁₂aralkyl, C₁-C₁₈alkoxy, C₅-C₈cycloalkoxy, C₇-C₉phenylalkoxy, C₁-C₈alkanoyl, C₃-C₅alkenoyl, C₁-C₁₈alkanoyloxy, benzyloxy, glycidyl or a group —CH₂CH(OH)—Z, where G₁₁ is preferably hydrogen, C₁-C₄alkyl, allyl, benzyl, acetyl or acryloyl,

Z is hydrogen, methyl or phenyl, and,

if n is 1,

G₁₂ is hydrogen, C₁-C₁₈alkyl, which is uninterrupted or interrupted by one or more oxygen atoms, or is cyanoethyl, benzyl, glycidyl, a monovalent radical of an aliphatic, cycloaliphatic, araliphatic, unsaturated or aromatic carboxylic acid, carbamic acid or phosphorus-containing acid or a monovalent silyl radical, preferably a radical of an aliphatic carboxylic acid having 2 to 18 carbon atoms, of a cycloaliphatic carboxylic acid having 7 to 15 carbon atoms, of an α,β-unsaturated carboxylic acid having 3 to 5 carbon atoms or of an aromatic carboxylic acid having 7 to 15 carbon atoms, it being possible for the carboxylic acid to be substituted in each case in the aliphatic, cycloaliphatic or aromatic moiety from 1 to 3 times by —COOZ₁₂,

Z₁₂ is hydrogen, C₁-C₂₀alkyl, C₃-C₁₂alkenyl, C₅-C₇cycloalkyl, phenyl or benzyl, and,

if n is 2,

G₁₂ is C₂-C₁₂alkylene, C₄-C₁₂alkenylene, xylylene, a divalent radical of an aliphatic, cycloaliphatic, araliphatic or aromatic dicarboxylic acid, dicarbamic acid or phosphorus-containing acid or a divalent silyl radical, preferably a radical of an aliphatic dicarboxylic acid having 2 to 36 carbon atoms, of a cycloaliphatic or aromatic dicarboxylic acid having 8 to 14 carbon atoms or of an aliphatic, cycloaliphatic or aromatic dicarbamic acid having 8 to 14 carbon atoms, it being possible for the dicarboxylic acid to be substituted in each case in the aliphatic, cycloaliphatic or aromatic moiety by 1 or 2 groups of —COOZ₁₂, and,

if n is 3,

G₁₂ is a trivalent radical of an aliphatic, cycloaliphatic or aromatic tricarboxylic acid, which can be substituted in the aliphatic, cycloaliphatic or aromatic moiety by —COOZ₁₂, of an aromatic tricarbamic acid or of a phosphorus-containing acid, or is a trivalent silyl radical, and,

if n is 4,

G₁₂ is a tetravalent radical of an aliphatic, cycloaliphatic or aromatic tetracarboxylic acid.

The carboxylic acid radicals indicated include in each case radicals of the formula (—CO)ₙR, in which the meaning of n is indicated above and the meaning of R is evident from the definition stated.

Any C₁-C₁₂alkyl substituents are, for example, methyl, ethyl, n-propyl, n-butyl, sec-butyl, tert-butyl, n-hexyl, n-octyl, 2-ethylhexyl, n-nonyl, n-decyl, n-undecyl or n-dodecyl.

As C₁-C₁₈alkyl G₁₁ or G₁₂ can be, for example, the groups indicated above and also, for example, n-tridecyl, n-tetradecyl, n-hexadecyl or n-octadecyl.

If G₁₁ is C₃-C₈alkenyl it can, for example, be 1-propenyl, allyl, methallyl, 2-butenyl, 2-pentenyl, 2-hexenyl, 2-octenyl or 4-tert-butyl-2-butenyl.

G₁₁ as C₃-C₈alkynyl is preferably propargyl.

G₁₁ as C₇-C₁₂aralkyl is especially phenethyl and in particular benzyl.

G₁₁ as C₁-C₈alkanoyl is, for example, formyl, propionyl, butyryl, octanoyl, but preferably acetyl and as C₃-C₅alkenoyl is especially acryloyl.

G₁₂ as a monovalent radical of a carboxylic acid is, for example, an acetic, caproic, stearic, acrylic, methacrylic, benzoic or β-(3,5-di-tert-butyl-4-hydroxyphenyl)propionic acid radical.

If G₁₂ is a monovalent silyl radical then it is, for example, a radical of the formula —(CⱼH₂ⱼ)—Si(Z′)₂Z″ in which j is an integer from the range from 2 to 5 and Z′ and Z″ independently of one another are C₁-C₄alkyl or C₁-C₄alkoxy.

If G₁₂ is a divalent radical of a dicarboxylic acid then it is, for example, a malonic, succinic, glutaric, adipic, suberic, sebacic, maleic, itaconic, phthalic, dibutylmalonic, dibenzylmalonic, butyl(3,5-di-tert-butyl-4-hydroxybenzyl)malonic or bicycloheptenedicarboxylic acid radical.

If G₁₂ is a trivalent radical of a tricarboxylic acid then it is, for example, a trimellitic, citric or nitrilotriacetic acid radical.

If G₁₂ is a tetravalent radical of a tetracarboxylic acid then it is, for example, the tetravalent radical of butane-1,2,3,4-tetracarboxylic acid or of pyromellitic acid.

If G₁₂ is a divalent radical of a dicarbamic acid then it is, for example, a hexamethylenedicarbamic or a 2,4-tolylenedicarbamic acid radical.

Preference is given to compounds of the formula XIIa in which G is hydrogen, G₁l is hydrogen or methyl, n is 2 and G₁₂ is the diacyl radical of an aliphatic dicarboxylic acid having 4 to 12 carbon atoms.

Examples of polyalkylpiperidine compounds of this class are the following compounds:

1) 4-Hydroxy-2,2,6,6-tetramethylpiperidine

2) 1-Allyl-4-hydroxy-2,2,6,6-tetramethylpiperidine

3) 1-Benzyl-4-hydroxy-2,2,6,6-tetramethylpiperidine

4) 1-(4-tert-Butyl-2-butenyl)-4-hydroxy-2,2,6,6-tetramethylpiperidine

5) 4-Stearoyloxy-2,2,6,6-tetramethylpiperidine

6) 1-Ethyl-4-salicyloyloxy-2,2,6,6-tetramethylpiperidine

7) 4-Methacryloyloxy-1,2,2,6,6-pentamethylpiperidine

8) 1,2,2,6,6-Pentamethylpiperidin-4-yl β-(3,5-di-tert-butyl-4-hydroxyphenyl)propionate

9) Di(1-benzyl-2,2,6,6-tetramethylpiperidin-4-yl) maleate

10) Di(2,2,6,6-tetramethylpiperidin-4-yl) succinate

11) Di(2,2,6,6-tetramethylpiperidin-4-yl) glutarate

12) Di(2,2,6,6-tetramethylpiperidin-4-yl) adipate

13) Di(2,2,6,6-tetramethylpiperidin-4-yl) sebacate

14) Di(1,2,2,6,6-pentamethylpiperidin-4-yl) sebacate

15) Di(1,2,3,6-tetramethyl-2,6-diethyl-piperidin-4-yl) sebacate

16) Di(1-allyl-2,2,6,6-tetramethylpiperidin-4-yl) phthalate

17) 1-Hydroxy-4-β-cyanoethyloxy-2,2,6,6-tetramethylpiperidine

18) 1-Acetyl-2,2,6,6-tetramethylpiperidin-4-yl acetate

19) Tri(2,2,6,6-tetramethylpiperidin-4-yl) trimellitate

20) 1-Acryloyl-4-benzyloxy-2,2,6,6-tetramethylpiperidine

21) Di(2,2,6,6-tetramethylpiperidin-4-yl) diethylmalonate

22) Di(1,2,2,6,6-pentamethylpiperidin-4-yl) dibutylmalonate

23) Di(1,2,2,6,6-pentamethylpiperidin-4-yl) butyl(3,5-di-tert-butyl-4-hydroxybenzyl)malonate

24) Di(1-octyloxy-2,2,6,6-tetramethylpiperidin-4-yl) sebacate

25) Di(1-cyclohexyloxy-2,2,6,6-tetramethylpiperidin-4-yl) sebacate

26) Hexane-1′,6′-bis(4-carbamoyloxy-1-n-butyl-2,2,6,6-tetramethylpiperidine)

27) Toluene-2′,4′-bis(4-carbamoyloxy-1-n-propyl-2,2,6,6-tetramethylpiperidine)

28) Dimethylbis(2,2,6,6-tetramethylpiperidin-4-oxy)silane

29) Phenyltris(2,2,6,6-tetramethylpiperidin-4-oxy)silane

30) Tris(1-propyl-2,2,6,6-tetramethylpiperidin-4-yl) phosphite

31) Tris(1-propyl-2,2,6,6-tetramethylpiperidin-4-yl) phosphate

32) Phenyl [bis(1,2,2,6,6-pentamethylpiperidin-4-yl)]phosphonate

33) 4-Hydroxy-1,2,2,6,6-pentamethylpiperidine

34) 4-Hydroxy-N-hydroxyethyl-2,2,6,6-tetramethylpiperidine

35) 4-Hydroxy-N-(2-hydroxypropyl)-2,2,6,6-tetramethylpiperidine

36) 1-Glycidyl-4-hydroxy-2,2,6,6-tetramethylpiperidine.

(b′) Compounds of the formula XIIb

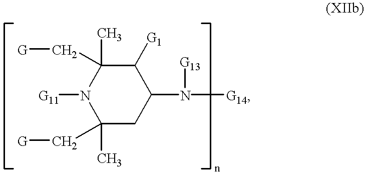

in which n is the number 1 or 2,

G, G₁ and G₁₁ are as defined under (a′),

G₁₃ is hydrogen, C₁-C₁₂alkyl, C₂-C₅hydroxyalkyl, C₅-C₇cycloalkyl, C₇-C₈aralkyl,

C₂-C₁₈alkanoyl, C₃-C₅alkenoyl, benzoyl or a group of the formula

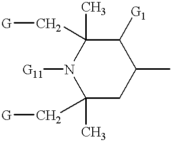

and,

if n is 1,

G₁₄ is hydrogen, C₁-C₁₈alkyl, C₃-C₈alkenyl, C₅-C₇cycloalkyl, or C₁-C₄alkyl substituted by a hydroxyl, cyano, alkoxycarbonyl or carbamide group; glycidyl, a group of the formula —CH₂—CH(OH)—Z or of the formula —CONH—Z, in which Z is hydrogen, methyl or phenyl, and

if n is 2,

G₁₄ is C₂-C₁₂alkylene, C₆-C₁₂arylene, xylylene, a —CH₂—CH(OH)—CH₂— group or a group —CH₂—CH(OH)—CH₂—O—D—O— in which D is C₂-C₁₀alkylene, C₆-C₁₅arylene, C₆-C₁₂cycloalkylene, or, provided that G₁₃ is not alkanoyl, alkenoyl or benzoyl, G₁₄ can alternatively be 1-oxo-C₂-C₁₂alkylene, a divalent radical of an aliphatic, cycloaliphatic or aromatic dicarboxylic acid or dicarbamic acid or else can be the group —CO—, or,

if n is 1,

G₁₃ and G₁₄ together can be the divalent radical of an aliphatic, cycloaliphatic or aromatic 1,2- or 1,3-dicarboxylic acid.

Any C₁-C₁₂- or C₁-C₁₈alkyl substituents are as already defined under (a′).

Any C₅-C₇cycloalkyl substituents are, in particular, cyclohexyl.

G₁₃ as C₇-C₈aralkyl is, in particular, phenylethyl or especially benzyl. As C₂-C₅hydroxyalkyl G₁₃ is, in particular, 2-hydroxyethyl or 2-hydroxypropyl.

G₁₃ as C₂-C₁₈alkanoyl is, for example, propionyl, butyryl, octanoyl, dodecanoyl, hexadecanoyl, octadecanoyl, but preferably acetyl, and as C₃-C₅alkenoyl is especially acryloyl.

If G₁₄ is C₂-C₈alkenyl it is, for example, allyl, methallyl, 2-butenyl, 2-pentenyl, 2-hexenyl or 2-octenyl.

G₁₄ as C₁-C₄alkyl substituted by a hydroxyl, cyano, alkoxycarbonyl or carbamide group can, for example, be 2-hydroxyethyl, 2-hydroxypropyl, 2-cyanoethyl, methoxycarbonylmethyl, 2-ethoxycarbonylethyl, 2-aminocarbonylpropyl or 2-(dimethylaminocarbonyl)ethyl.

Any C₂-C₁₂alkylene substituents are, for example, ethylene, propylene, 2,2-dimethyl-propylene, tetramethylene, hexamethylene, octamethylene, decamethylene or dodecamethylene.

Any C₆-C₁₅arylene substituents are, for example, o-, m- or p-phenylene, 1,4-naphthylene or 4,4′-diphenylene.

As C₆-C₁₂cycloalkylene particular mention may be made of cyclohexylene.

Preference is given to compounds of the formula Ib in which n is 1 or 2, G is hydrogen, G₁₁ is hydrogen or methyl, G₁₃ is hydrogen, C₁-C₁₂alkyl or a group of the formula

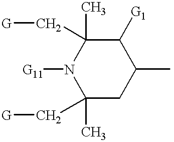

and G₁₄, if n=1, is hydrogen or C₁-C₁₂alkyl and, if n=2, is C₂-C₈alkylene or 1-oxo-C₂-C₈alkylene.

Examples of polyalkylpiperidine compounds of this class are the following compounds:

37) N,N′-Bis(2,2,6,6-tetramethylpiperidin-4-yl)hexamethylene-1,6-diamine

38) N,N′-Bis(2,2,6,6-tetramethylpiperidin-4-yl)hexamethylene-1,6-diacetamide

39) Bis(2,2,6,6-tetramethylpiperidin-4-yl)amine

40) 4-Benzoylamino-2,2,6,6-tetramethylpiperidine

41) N,N′-Bis(2,2,6,6-tetramethylpiperidin-4-yl)-N,N′-dibutyladipamide

42) N,N′-Bis(2,2,6,6-tetramethylpiperidin-4-yl)-N,N′-dicyclohexyl-2-hydroxypropylene-1,3-diamine

43) N,N′-Bis(2,2,6,6-tetramethylpiperidin-4-yl)-p-xylylenediamine

44) N,N′-Bis(2,2,6,6-tetramethylpiperidin-4-yl)succinamide

45) Di(2,2,6,6-tetramethylpiperidin-4-yl) N-(2,2,6,6-tetramethylpiperidin-4-yl)-β-amino-dipropionate

46) The compound of the formula

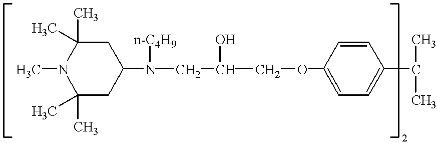

47) 4-(Bis-2-hydroxyethylamino)-1,2,2,6,6-pentamethylpiperidine

48) 4-(3-Methyl-4-hydroxy-5-tert-butylbenzamido)-2,2,6,6-tetramethylpiperidine

49) 4-Methacrylamido-1,2,2,6,6-pentamethylpiperidine

(c′) Compounds of the formula XIIc

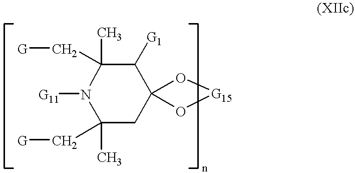

in which n is the number 1 or 2, G, G₁ and G₁₁ are as defined under (a′), and,

if n is 1,

G₁₅ is C₂-C₈alkylene or C₂-C₈hydroxyalkylene or C₄-C₂₂acyloxyalkylene, and,

if n is 2,

G₁₅ is the group (—CH₂)₂C(CH₂—)₂.

If G₁₅ is C₂-C₈alkylene or C₂-C₈hydroxyalkylene then it is, for example, ethylene, 1-methyl-ethylene, propylene, 2-ethylpropylene or 2-ethyl-2-hydroxymethylpropylene.

G₁₅ as C₄-C₂₂acyloxyalkylene is, for example, 2-ethyl-2-acetoxymethylpropylene.

Examples of polyalkylpiperidine compounds of this class are the following compounds:

50) 9-Aza-8,8,10,10-tetramethyl-1,5-dioxaspiro[5.5]undecane

51) 9-Aza-8,8,10,10-tetramethyl-3-ethyl-1,5-dioxaspiro[5.5]undecane

52) 8-Aza-2,7,7,8,9,9-hexamethyl-1,4-dioxaspiro[4.5]decane

53) 9-Aza-3-hydroxymethyl-3-ethyl-8,8,9,10,10-pentamethyl-1,5-dioxaspiro[5.5]undecane

54) 9-Aza-3-ethyl-3-acetoxymethyl-9-acetyl-8,8,10,10-tetramethyl-1,5-dioxaspiro[5.5]-undecane

55) 2,2,6,6-Tetramethylpiperidine-4-spiro-2′-(1′,3′-dioxane)-5′-spiro-5″-(1″,3″-dioxane)-2″-spiro-4″′-(2″′,2″′,6″′,6″′-tetramethylpiperidine).

(d′) Compounds of the formulae XIId, XIIe and XIIf, with compounds of the formula XIIf being preferred

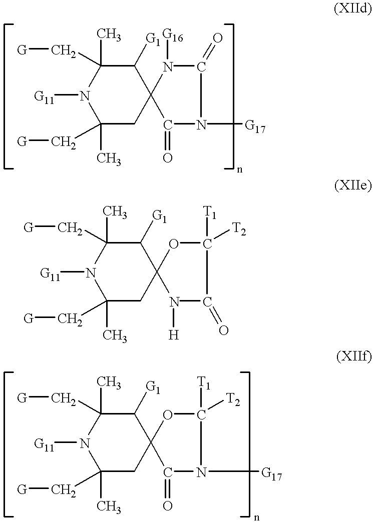

in which n is the number 1 or 2, G, G₁ and G₁₁ are as defined under (a′),

G₁₆ is hydrogen, C₁-C₁₂alkyl, allyl, benzyl, glycidyl or C₂-C₆alkoxyalkyl, and,

if n is 1,

G₁₇ is hydrogen, C₁-C₁₂alkyl, C₃-C₅alkenyl, C₇-C₉aralkyl, C₅-C₇cycloalkyl, C₂-C₄hydroxyalkyl, C₂-C₆alkoxyalkyl, C₆-C₁₀aryl, glycidyl or a group of the formula —(CH₂)p—COO—Q or of the formula —(CH₂)p—O—CO—Q in which p is 1 or 2 and Q is C₁-C₄alkyl or phenyl, and,

if n is 2,

G₁₇ is C₂-C₁₂alkylene, C₄-C₁₂alkenylene, C₆-C₁₂arylene, a group —CH₂—CH(OH)—CH₂—O—D—O—CH₂—CH(OH)—CH₂— in which D is C₂-C₁₀alkylene, C₆-C₁₅arylene, C₆-C₁₂cycloalkylene, or a group —CH₂CH(OZ′)CH₂—(OCH₂—CH(OZ′)CH₂)₂— in which Z′ is hydrogen, C₁-C₁₈alkyl, allyl, benzyl, C₂-C₁₂alkanoyl or benzoyl,

T₁ and T₂ independently of one another are hydrogen, C₁-C₁₈alkyl or unsubstituted or halo- or C₁-C₄alkyl-substituted C₆-C₁₀aryl or C₇-C₉aralkyl or T₁ and T₂, together with the carbon atom to which they are attached, form a C₅-C₁₄cycloalkane ring.

Any C₁-C₁₂alkyl substituents are, for example, methyl, ethyl, n-propyl, n-butyl, sec-butyl, tert-butyl, n-hexyl, n-octyl, 2-ethylhexyl, n-nonyl, n-decyl, n-undecyl or n-dodecyl.

Any substituents in the meaning of C₁-C₁₈alkyl can, for example, be the groups listed above and also, for example, n-tridecyl, n-tetradecyl, n-hexadecyl or n-octadecyl.

Any C₂-C₆alkoxyalkyl substituents are, for example, methoxymethyl, ethoxymethyl, propoxymethyl, tert-butoxymethyl, ethoxyethyl, ethoxypropyl, n-butoxyethyl, tert-butoxyethyl, isopropoxyethyl or propoxypropyl.

If G₁₇ is C₃-C₅alkenyl then it is, for example, 1-propenyl, allyl, methallyl, 2-butenyl or 2-pentenyl.

G₁₇, T₁ and T₂ as C₇-C₉aralkyl are, in particular, phenethyl or, especially, benzyl. If T₁ and T₂ together with the carbon atom form a cycloalkane ring then this can, for example, be a cyclopentane, cyclohexane, cyclooctane or cyclododecane ring.

If G₁₇ is C₂-C₄hydroxyalkyl then it is, for example, 2-hydroxyethyl, 2-hydroxypropyl, 2-hydroxybutyl or 4-hydroxybutyl.

G₁₇, T₁ and T₂ as C₆-C₁₀aryl are, in particular, phenyl, α- or β-naphthyl which are unsubstituted or substituted by halogen or C₁-C₄alkyl.

If G₁₇ is C₂-C₁₂alkylene then it is, for example, ethylene, propylene, 2,2-dimethylpropylene, tetramethylene, hexamethylene, octamethylene, decamethylene or dodecamethylene.

G₁₇ as C₄-C₁₂alkenylene is, in particular, 2-butenylene, 2-pentenylene or 3-hexenylene.

If G₁₇ is C₆-C₁₂arylene then it is, for example, o-, m- or p-phenylene, 1,4-naphthylene or 4,4′-diphenylene.

If Z′ is C₂-C₁₂alkanoyl then it is, for example, propionyl, butyryl, octanoyl, dodecanoyl, but preferably acetyl.

D as C₂-C₁₀alkylene, C₆-C₁₅arylene or C₆-C₁₂cycloalkylene is as defined under (b′).

Examples of polyalkylpiperidine compounds of this class are the following compounds:

56) 3-Benzyl-1,3,8-triaza-7,7,9,9-tetramethylspiro[4.5]decane-2,4-dione

57) 3-n-Octyl-1,3,8-triaza-7,7,9,9-tetramethylspiro[4.5]decane-2,4-dione

58) 3-Allyl-1,3,8-triaza-1,7,7,9,9-pentamethylspiro[4.5]decane-2,4-dione

59) 3-Glycidyl-1,3,8-triaza-7,7,8,9,9-pentamethylspiro[4.5]decane-2,4-dione

60) 1,3,7,7,8,9,9-Heptamethyl-1,3,8-triazaspiro[4.5]decane-2,4-dione

61) 2-lsopropyl-7,7,9,9-tetramethyl-1-oxa-3,8-diaza-4-oxospiro[4.5]decane

62) 2,2-Dibutyl-7,7,9,9-tetramethyl-1-oxa-3,8-diaza-4-oxospiro[4.5]decane

63) 2,2,4,4-Tetramethyl-7-oxa-3,20-diaza-21-oxodispiro[5.1.11.2]heneicosane

64) 2-Butyl-7,7,9,9-tetramethyl-1-oxa-4,8-diaza-3-oxospiro[4.5]decane and preferably:

65) 8-Acetyl-3-dodecyl-1,3,8-triaza-7,7,9,9-tetramethylspiro[4.5]decane-2,4-dione

or the compounds of the following formulae:

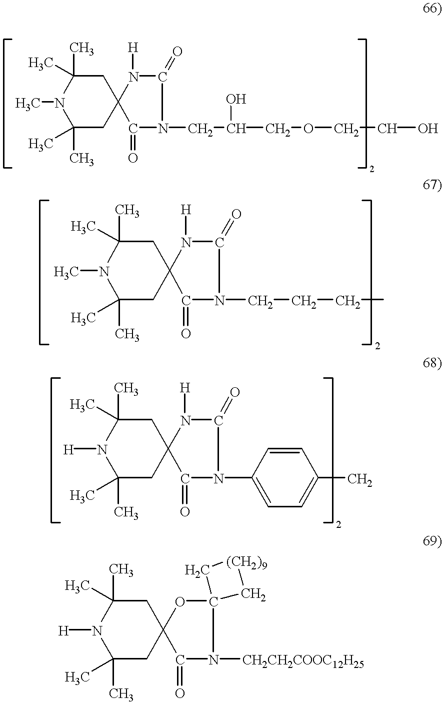

(e′) Compounds of the formula XIIg, which in turn are preferred

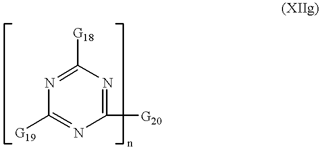

in which n is the number 1 or 2 and G₁₈ is a group of one of the formulae

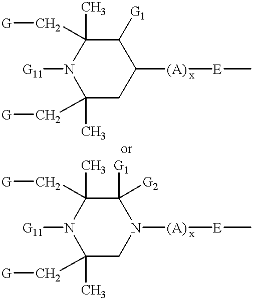

in which G and G₁₁ are as defined under (a′),

G₁ and G₂ are hydrogen, methyl or together are a substituent ═O,

E is —O— or —NG₁₃—,

A is C₂-C₆alkylene or —(CH₂)₃—O—,

x is the number 0 or 1,

G₁₃ is hydrogen, C₁-C₁₂alkyl, C₂-C₅hydroxyalkyl or C₅-C₇cycloalkyl,

G₁₉ is the same as G₁₈ or is one of the groups —NG₂₁G₂₂, —OG₂₃, —NHCH₂OG₂₃ or —N(CH₂OG₂₃)₂,

G₂₀, if n=1, is the same as G₁₈ or G₁₉ and, if n=2, G₂₀ is a group -E-B-E-, in which B is C₂-C₈alkylene or C₂-C₈alkylene which is interrupted by 1 or 2 groups —N(G₂₁)—,

G₂₁ is C₁-C₁₂alkyl, cyclohexyl, benzyl or C₁-C₄hydroxyalkyl or a group of the formula

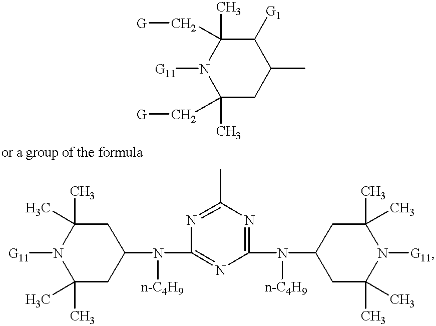

G₂₂ is C₁-C₁₂alkyl, cyclohexyl, benzyl or C₁-C₄hydroxyalkyl, or G₂₁ and G₂₂ together are C₄-C₅alkylene or C₄-C₅oxaalkylene such as, for example, —CH₂CH₂OCH₂CH₂— or a group of the formula —CH₂CH₂N(G₁₁)CH₂CH₂—, and

G₂₃ is hydrogen, C₁-C₁₂alkyl or phenyl.

Any C₁-C₁₂alkyl substituents are, for example, methyl, ethyl, n-propyl, n-butyl, sec-butyl, tert-butyl, n-hexyl, n-octyl, 2-ethylhexyl, n-nonyl, n-decyl, n-undecyl or n-dodecyl.

Any C₂-C₅hydroxyalkyl substituents are, for example, 2-hydroxyethyl, 2-hydroxypropyl, 3-hydroxypropyl, 2-hydroxybutyl or 4-hydroxybutyl.

If A is C₂-C₆alkylene then it is, for example, ethylene, propylene, 2,2-dimethylpropylene, tetramethylene or hexamethylene.

If G₂₁, and G₂₂ together are C₄-C₅alkylene or oxaalkylene then this is, for example, tetramethylene, pentamethylene or 3-oxapentamethylene.

Examples of polyalkylpiperidine compounds of this class are the compounds of the following formulae:

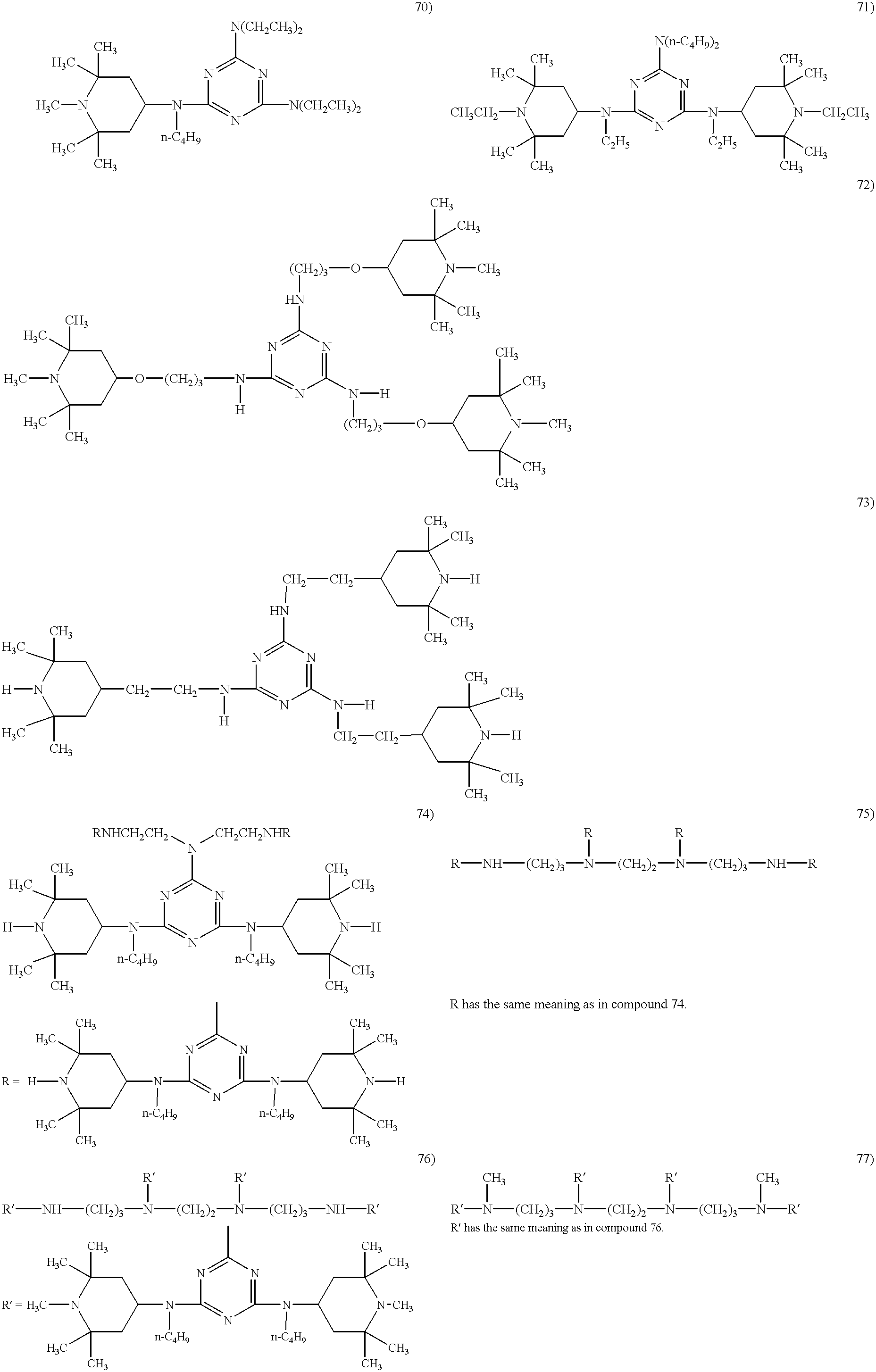

(f′) Oligomeric or polymeric compounds whose structural repeating unit contains a 2,2,6,6-tetraalkylpiperidine radical, especially polyesters, polyethers, polyamides, poly-amines, polyurethanes, polyureas, polyaminotriazines, poly(meth)acrylates, poly(meth)-acrylamides and copolymers thereof which include such radicals.

Examples of 2,2,6,6-polyalkylpiperidine compounds of this class are the compounds of the following formulae, in which m is a number from 2 to about 200.

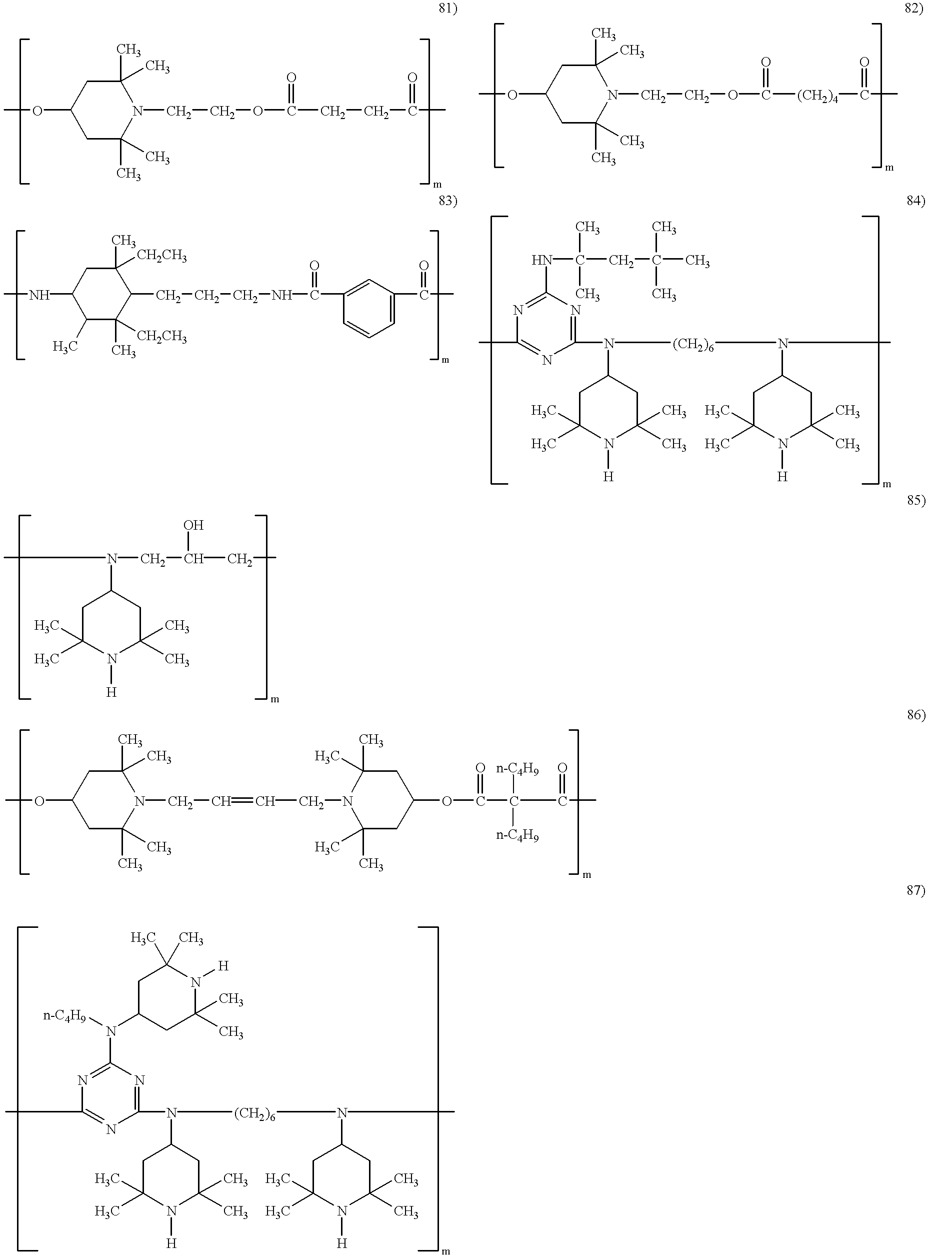

in which R is a radical of the formula

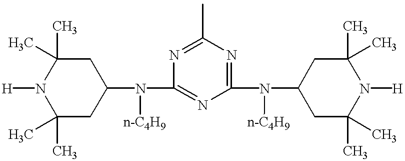

or is a chain branch

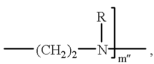

m′ and m″ are each an integer from the range from 0 to 200, with the proviso that m′+m″=m.

Further examples of polymeric compounds are reaction products of compounds of the formula

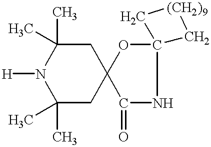

with epichlorohydrin; polyesters of butane-1,2,3,4-tetracarboxylic acid with a bifunctional alcohol of the formula

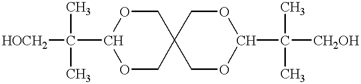

whose carboxyl side chains originating from the tetracarboxylic acid are esterified with 2,2,6,6-tetramethyl-4-hydroxypiperidine; compounds of the formula

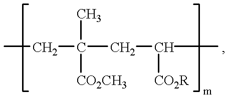

in which about a third of the radicals R are —C₂H₅ and the others are

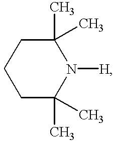

and m is a number from the range from 2 to 200; or copolymers whose repeating unit is composed of two units

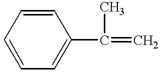

and in each case one unit

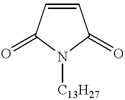

and one unit

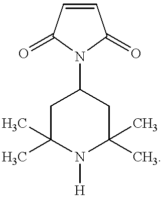

(g′) Compounds of the formula XIIIa

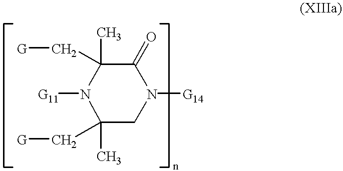

in which n is the number 1 or 2 and in which G and G₁₁ are as defined under (a′) and G₁₄ is as defined under (b′), the meanings —CONH—Z and —CH₂—CH(OH)—CH₂—O—D—O— being excluded for G₁₄.

Examples of such compounds are:

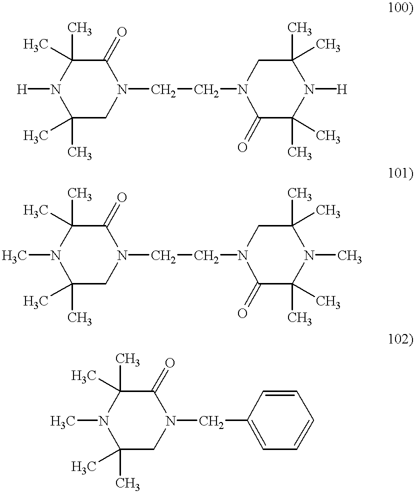

Of particular interest are compositions comprising as component (e) at least one compound of the formula H1, H2, H3, H4, H5 or H6

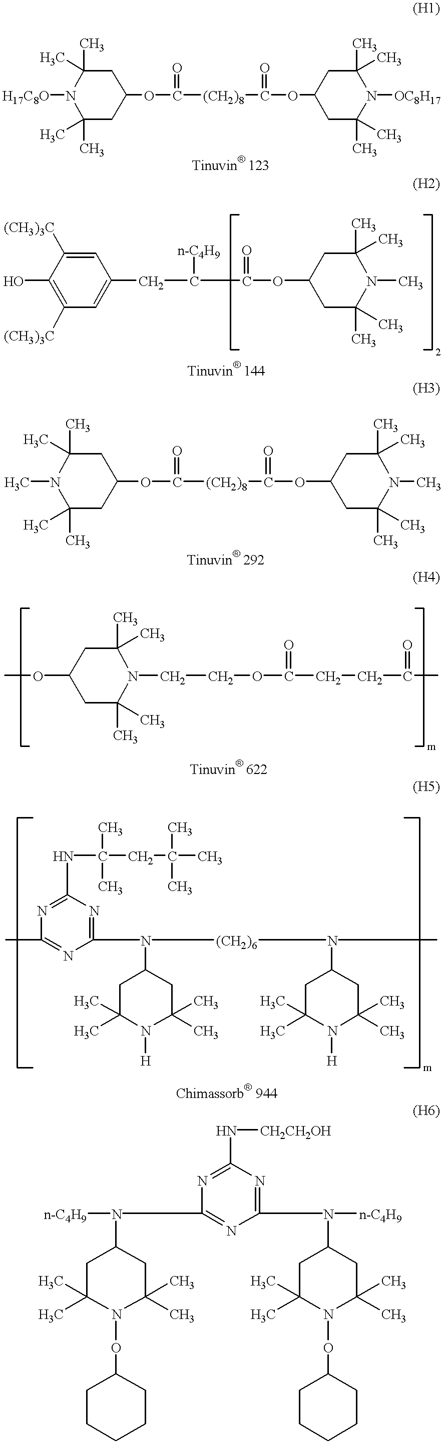

in which

m is a number from the range from 2 to 200.

The compounds of the sterically hindered amine type are known and some are commercially available.

Tinuvin®123, Tinuvin®144, Tinuvin®292, Tinuvin®622 and Chimassorb®944 are protected trade names of Ciba Spezialitätenchemie AG.

Also of particular interest in the novel composition is Chimassorb®119 (Ciba Spezialitätenchemie AG). Chimassorb®119 is a condensation product prepared from 2-chloro-4,6-di(4-n-butylamino-1,2,2,6,6-pentamethylpiperidyl)-1,3,5-triazine and 1,2-bis(3-aminopropylamino)ethane.

As a component of the novel composition particular preference is given to the addition of those sterically hindered amines whose molecular weight or average molecular weight Mₙ is in the range from 500 to 10 000, in particular in the range from 1000 to 10 000. Of these, particular emphasis should again be placed on those sterically hindered amines whose molecular weight or average molecular weight Mₙ is in the range from 1500 to 10 000, for example in the range from 2000 to 7500.

As UV absorbers, particular mention may be made of:

2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)-benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octoxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)-benzotriazole, mixture of 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)-benzotriazole, 2-(3′-tert-butyl-2′-hydroxy-5′-(2-octyloxycarbonylethyl)phenyl)-benzotriazole, 2-(3′-tert-butyl-5′-[2-(2-ethylhexyloxy)carbonylethyl]-2′-hydroxyphenyl)-benzotriazole, 2-(3′-dodecyl-2′-hydroxy-5′-methylphenyl)benzotriazole and 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the transesterification product of 2-[3′-tert-butyl-5′-(2-methoxy-carbonylethyl)-2′-hydroxyphenyl]benzotriazole with polyethylene glycol 300;

[RCH₂CH₂COOCH₂CH₂]₂ where R=3′-tert-butyl-4′-hydroxy-5′-2H-benzotriazol-2-ylphenol.

2-Hydroxybenzophenones, for example the 4-hydroxy, 4-methoxy, 4-octoxy, 4-decyloxy, 4-dodecyloxy, 4-benzyloxy, 4,2′,4′-trihydroxy and 2′-hydroxy-4,4′-dimethoxy derivative.

Esters of substituted or unsubstituted benzoic acids, for example 4-tert-butyl-phenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

Acrylates, for example ethyl α-cyano-β,β-diphenylacrylate or isooctyl α-cyano-β,β-diphenylacrylate, methyl α-carbomethoxycinnamate, methyl α-cyano-β-methyl-p-methoxy-cinnamate or butyl α-cyano-β-methyl-p-methoxycinnamate, methyl α-carbomethoxy-p-methoxycinnamate and N-(β-carbomethoxy-β-cyanovinyl)-2-methylindoline.

Oxalamides, for example 4,4′-dioctyloxyoxanilide, 2,2′-diethoxy-oxanilide, 2,2′-dioctyloxy-5,5′-di-tert-butoxanilide, 2,2′-didodecyloxy-5,5′-di-tert-butyloxanilide, 2-ethoxy-2′-ethyloxanilide, N,N′-bis(3-dimethylaminopropyl)oxalamide, 2-ethoxy-5-tert-butyl-2′-ethyloxanilide and its mixture with 2-ethoxy-2′-ethyl-5,4′-di-tert-butoxanilide and mixtures of o- and p-methoxy and of o- and p-ethoxy-disubstituted oxanilides.

2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)-phenyl]-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine.

Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of monoalkyl esters, such as of the methyl or ethyl ester, of 4-hydroxy-3,5-di-tert-butylbenzylphosphonic acid, nickel complexes of ketoximes, e.g. of 2-hydroxy-4-methylphenyl undecyl ketoxime, nickel complexes of 1-phenyl-4-lauroyl-5-hydroxypyrazole, with or without additional ligands.

Further additives that may be present include:

Hydroxylamines, for example N,N-dibenzylhydroxylamine, N,N-diethylhydroxylamine, N,N-dioctylhydroxylamine, N,N-dilaurylhydroxylamine, N, N-ditetradecylhydroxylamine, N,N-dihexadecylhydroxylamine, N, N-dioctadecylhydroxylamine, N-hexadecyl-N-octadecylhydroxylamine, N-heptadecyl-N-octadecylhydroxylamine, N,N-dialkylhydroxylamine from hydrogenated tallow fatty amines.

Nitrones, for example N-benzyl alpha-phenyl nitrone, N-ethyl alpha-methyl nitrone, N-octyl alpha-heptyl nitrone, N-lauryl alpha-undecyl nitrone, N-tetradecyl alpha-tridecyl nitrone, N-hexadecyl alpha-pentadecyl nitrone, N-octadecyl alpha-heptadecyl nitrone, N-hexadecyl alpha-heptadecyl nitrone, N-octadecyl alpha-pentadecyl nitrone, N-heptadecyl alpha-heptadecyl nitrone, N-octadecyl alpha-hexadecyl-nitrone, and nitrones derived from N,N-dialkylhydroxylamines prepared from hydrogenated tallow fatty amines.

Thiosynergists, for example dilauryl thiodiproprionate or distearyl thiodipropionate.

Peroxide scavengers, for example esters of β-thiodipropionic acid, for example the lauryl, stearyl, myristyl or tridecyl esters, mercaptobenzimidazole, the zinc salt of 2-mercaptobenzimidazole, zinc dibutyldithiocarbamate, dioctadecyl disulfide, pentaerythritol tetrakis(β-dodecylmercapto)propionate.

Polyamide stabilizers, for example copper salts in combination with iodides and/or phosphorus compounds and salts of divalent manganese.

Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate, potassium palmitate, antimony pyrocatecholate or zinc pyrocatecholate.

Nucleating agents, for example inorganic substances, such as talc, metal oxides such as titanium dioxide or magnesium oxide, phosphates, carbonates or sulfates of, preferably, alkaline earth metals; organic compounds such as mono- or polycarboxylic acids and their salts, such as 4-tert-butylbenzoic acid, adipic acid, diphenyl acetic acid, sodium succinate or sodium benzoate; and polymeric compounds, for example ionic copolymers (ionomers).

Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibres of other natural products, and synthetic fibres.

Other additives, for example plasticizers, lubricants, emulsifiers, pigments, rheological additives, catalysts, levelling assistants, optical brighteners, flame retardants, antistats, blowing agents.

Benzofuranones and indolinones, as described, for example, in U.S. Pat. No. 4,325,863, U.S. Pat. No. 4,338,244, U.S. Pat. No. 5,175,312, U.S. Pat. No. 5,216,052, U.S. Pat. No. 5,252,643, DE-A-4 316 611, DE-A-4 316 622, DE-A-4 316 876, EP-A-0 589 839 or EP-A-0 591 102, or 3-[4-(2-acetoxy-ethoxy)phenyl]-5,7-di-tert-butylbenzofuran-2-one, 5,7-di-tert-butyl-3-[4-(2-stearoyloxyethoxy)-phenyl]-benzofuran-2-one, 3,3′-bis[5,7-di-tert-butyl-3-(4-[2-hydroxyethoxy]phenyl)-benzofuran-2-one], 5,7-di-tert-butyl-3-(4-ethoxyphenyl)benzofuran-2-one, 3-(4-acetoxy-3,5-dimethyl-phenyl)-5,7-di-tert-butylbenzofuran-2-one, 3-(3,5-dimethyl-4-pivaloyloxyphenyl)-5,7-di-tert-butyl-benzofuran-2-one.

Preferred metal oxides are the oxides of divalent metals. Particular preference is given to oxides of the metals of the second main group or subgroup, very particular preference being given to zinc oxide, calcium oxide and magnesium oxide.

The amount of the metal oxides depends on the intended use of the plastics additive granules; judiciously, the granules comprise 0-90% by weight, preferably 5-60% by weight, of metal oxide.

Preferred metal carbonates are the carbonates of divalent metals. Particular preference is given to carbonates of metals of the second main group or subgroup.

The amount of the metal carbonates depends on the intended use of the plastics additive granules; judiciously, the granules comprise 0-90% by weight.

A metal soap in the context of this invention is a metal salt of a fatty acid, it being possible for the metal to be, in particular, an element of the second main group or subgroup, or tin.

The compounds concerned here are, in particular, calcium salts, magnesium salts, tin salts or zinc salts from the series of the aliphatic saturated C₂-C₂₂carboxylates, of the aliphatic olefinic C₃-C₂₂carboxylates, of the aliphatic C₂-C₂₂carboxylates substituted by at least one OH group, of the cyclic or bicyclic C₅-C₂₂carboxylates, of the aromatic C₇-C₂₂carboxylates, of the aromatic C₇-C₂₂carboxylates, substituted by at least one OH group, of the C₁-C₁₆alkyl-substituted phenylcarboxylates and of the phenyl-C₁-C₁₆alkylcarboxylates, preference being given to stearates and laurates and behenates.

The amount of the further metal soap depends on the intended use of the plastics additive granules; judiciously, the granules comprise 0-90% by weight, preferably 5-60% by weight, of a further metal soap.

The epoxy compounds b) which can be used in the context of the invention may have an aliphatic, aromatic, cycloaliphatic, araliphatic or heterocyclic structure; they include epoxy groups as side groups. The epoxy groups are preferably attached to the rest of the molecule as glycidyl groups by way of ether or ester linkages, or else the compounds are N-glycidyl derivatives of heterocyclic amines, amides or imides. Epoxy compounds of these types are widely known and are obtainable commercially.

The epoxy compounds comprise epoxy radicals, especially those of the formula A

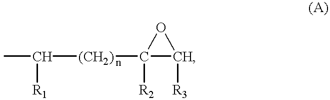

which are attached directly to carbon, oxygen, nitrogen or sulfur atoms and in which R₁ and R₃ are both hydrogen, R₂ is hydrogen or methyl and n is 0, or in which R₁ and R₃ together are —CH₂—CH₂— or —CH₂—CH₂—CH₂—, R₂ in that case is hydrogen, and n is 0 or 1.

Examples of epoxy compounds that may be mentioned are:

I) Polyglycidyl esters and poly(β-methylglycidyl) esters obtainable by reacting a compound having at least two carboxyl groups in the molecule with epichlorohydrin and/or glyceroldichlorohydrin and/or β-methylepichlorohydrin. The reaction is judiciously carried out in the presence of bases.

Compounds having at least two carboxyl groups in the molecule that can be used are aliphatic polycarboxylic acids. Examples of these polycarboxylic acids are glutaric, adipic, pimelic, suberic, azelaic, sebacic or dimerized or trimerized linoleic acid.

Alternatively, cycloaliphatic polycarboxylic acids can be employed, examples being tetra-hydrophthalic, 4-methyltetrahydrophthalic, hexahydrophthalic or 4-methylhexahydrophthalic acid.

It is also possible to use aromatic polycarboxylic acids, such as phthalic, isophthalic, trimellitic and pyromellitic acid.

Likewise employable are carboxyl-terminated adducts of, for example, trimellitic acid and polyols such as glycerol or 2,2-bis(4-hydroxycyclohexyl)propane.

II) Polyglycidyl ethers or poly(P-methylglycidyl) ethers obtainable by reacting a compound having at least two free alcoholic hydroxyl groups and/or phenolic hydroxyl groups with a suitably substituted epichlorohydrin under alkaline conditions or in the presence of an acidic catalyst with subsequent alkali treatment.

Ethers of this type are derived, for example, from acyclic alcohols, such as ethyleneglycol, diethyleneglycol and higher poly(oxyethylene) glycols, propane-1,2-diol, or poly(oxy-propylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, bis-trimethylolpropane, pentaerythritol, sorbitol, and from polyepichlorohydrins.

They are alternatively derived, for example, from cycloaliphatic alcohols, such as 1,3- or 1,4-dihydroxycyclohexane, bis(4-hydroxycyclohexyl)methane, 2,2-bis(4-hydroxycyclohexyl)-propane or 1,1-bis(hydroxymethyl)cyclohex-3-ene, or they possess aromatic nuclei, such as N,N-bis(2-hydroxyethyl)aniline or p,p′-bis(2-hydroxyethylamino)diphenylmethane.

The epoxy compounds may also be derived from mononuclear phenols, such as resorcinol or hydroquinone; or else they are based on polynuclear phenols, such as on bis(4-hydroxy-phenyl)methane, 2,2-bis(4-hydroxyphenyl)propane, 2,2-bis(3,5-dibromo-4-hydroxyphenyl)-propane or 4,4′-dihydroxydiphenyl sulfone, or on condensates of phenols with formaldehyde that are obtained under acidic conditions, such as phenol novolaks.

III) Poly(N-glycidyl) compounds obtainable by dehydrochlorinating the reaction products of epichlorohydrin with amines containing at least two amino hydrogen atoms. These amines are, for example, aniline, toluidine, n-butylamine, bis(4-aminophenyl)methane, m-xylylene-diamine or bis(4-methylaminophenyl)methane, and also N,N,O-triglycidyl-m-aminophenol or N,N,O-triglycidyl-p-aminophenol.

The poly(N-glycidyl) compounds also include N,N′-diglycidyl derivatives of cycloalkylene-ureas, such as ethyleneurea or 1,3-propyleneurea, and N,N′-diglycidyl derivatives of hydantoins, such as of 5,5-dimethylhydantoin.

IV) Poly(S-glycidyl) compounds, such as di-S-glycidyl derivatives derived from dithiols, such as ethane-1,2-dithiol or bis(4-mercaptomethylphenyl) ether.

V) Epoxy compounds having a radical of the formula A, in which R₁ and R₃ together are —CH₂—CH₂— and n is 0 are bis(2,3-epoxycyclopentyl) ether, 2,3-epoxycyclopentyl glycidyl ether or 1,2-bis(2,3-epoxycyclopentyloxy) ethane. An example of an epoxy resin having a radical of the formula A in which R₁ and R₃together are —CH₂—CH₂— and n is 1 is (3,4-epoxy-6-methylcyclohexyl)methyl 3′,4′-epoxy-6′-methylcyclohexanecarboxylate.

Examples of suitable epoxides are:

a) liquid bisphenol A diglycidyl ethers, such as Araldit®GY 240, Araldit®GY 250, Araldit®GY 260, Araldit®GY 266, Araldit®GY 2600, Araldit®MY 790;

b) solid bisphenol A diglycidyl ethers such as Araldit®GT 6071, Araldit®GT 7071, Araldit®GT 7072, Araldit®GT 6063, Araldit®GT 7203, Araldit®GT 6064, Araldit®GT 7304, Araldit®GT 7004, Araldit®GT 6084, Araldit®GT 1999, Araldit®GT 7077, Araldit®GT 6097, Araldit®GT 7097, Araldit®GT 7008, Araldit®GT 6099, Araldit®GT 6608, Araldit®GT 6609, Araldit®GT 6610;

c) liquid bisphenol F diglycidyl ethers, such as Araldit®GY 281, Araldit®GY282, Araldit®PY 302, Araldit®PY 306;

d) solid polyglycidyl ethers of tetraphenylethane, such as CG Epoxy Resin®0163;

e) solid and liquid polyglycidyl ethers of phenol-formaldehyde Novolak, such as EPN 1138, EPN 1139, GY 1180, PY307;

f) solid and liquid polyglycidyl ethers of o-cresol-formaldehyde Novolak, such as ECN 1235, ECN 1273, ECN 1280, ECN 1299;

g) liquid glycidyl ethers of alcohols, such as Shell® glycidyl ether 162, Araldit®DY 0390, Araldit®DY 0391;

h) liquid glycidyl ethers of carboxylic acids, such as Shell® Cardura E terephthalic ester, trimellitic ester, Araldit®PY 284;

i) solid heterocyclic epoxy resins (triglycidyl isocyanurate), such as Araldit®PT 810;

j) liquid cycloaliphatic epoxy resins, such as Araldit®CY 179;

k) liquid N,N,O-triglycidyl ethers of p-aminophenol, such as Araldit®MY 0510;

l) tetraglycidyl-4,4′-methylenebenzamine or N,N,N′,N′-tetraglycidyldiaminophenylmethane, such as Araldit®MY 720, Araldit®MY 721.

If desired, a mixture of epoxy compounds of different structure can also be employed.

Compound b) preferably comprises at least two groups of the formula

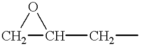

Particular preference as component b) is given to compounds of types (I) to (Ill) and/or mixtures of them

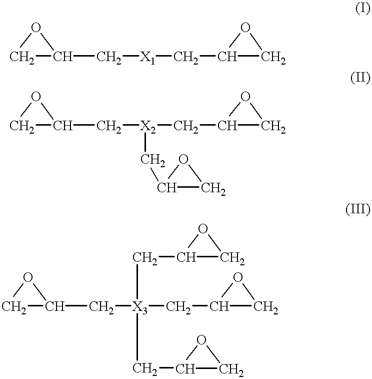

in which X₁, X₂ and X₃ are cyclohexylene, phenylene or naphthylene which can be unsubstituted or substituted and X₁ is additionally an unsubstituted or substituted radical of the formula

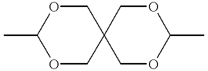

and X₂ is additionally an unsubstituted or substituted radical of the formula

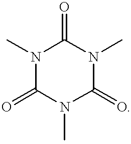

Suitable substituents for the abovementioned radicals are —O—, —S—, —C(O)—, —C(O)O—, —S(O)—, —S(O₂)—, —C(CF₃)₂—, alkyl, alkylene, aryl, arylene, alkoxy, aryloxy or halogen, it also being possible for identical or different substituents to be present two or more times or for the substituents themselves to be substituted in turn.

An example of a suitable alkyl radical is a C₁-C₁₈alkyl radical, such as methyl, ethyl, n-propyl, n-butyl, sec-butyl, tert-butyl, n-hexyl, n-octyl, 2-ethylhexyl, n-nonyl, n-decyl, n-undecyl, n-dodecyl, n-tridecyl, n-tetradecyl, n-hexadecyl or n-octadecyl, and their branched isomers.

Possible alkylene and alkoxy radicals can be derived formally from the abovementioned alkyl radicals by removing a further hydrogen atom or, respectively, by adding an oxygen atom.

Examples of suitable aryl radicals are those having 6-20 carbon atoms, such as phenylene, biphenylene or naphthylene.

Possible arylene and aryloxy radicals can be derived formally from the abovementioned aryl radicals by removing a further hydrogen atom or, respectively, by adding an oxygen atom.

Preference is given to radicals of the following formulae:

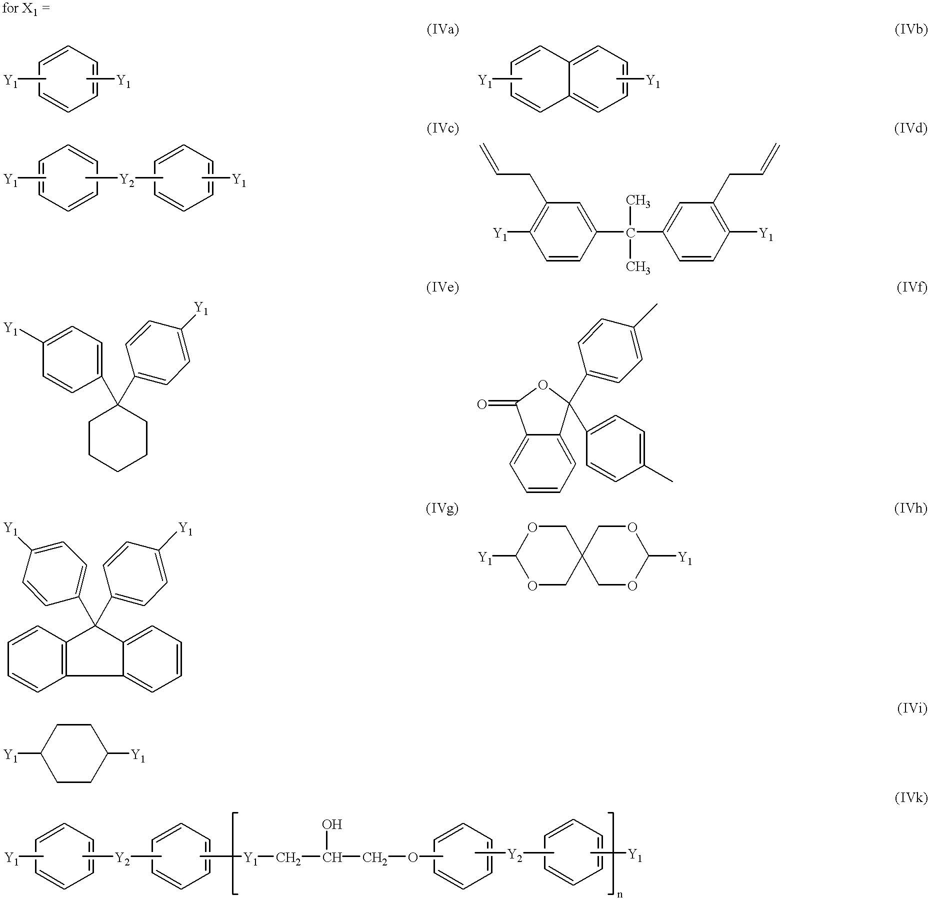

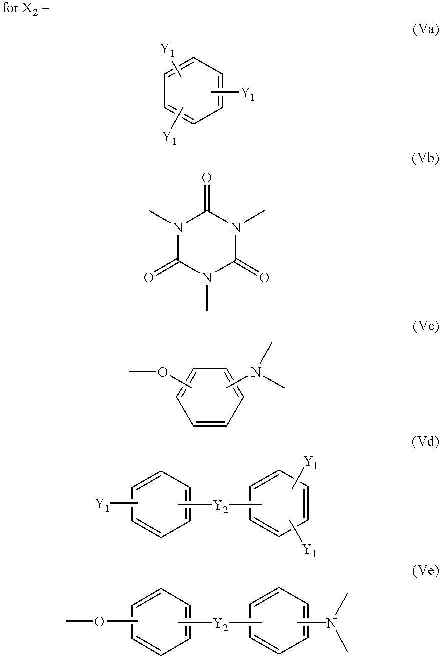

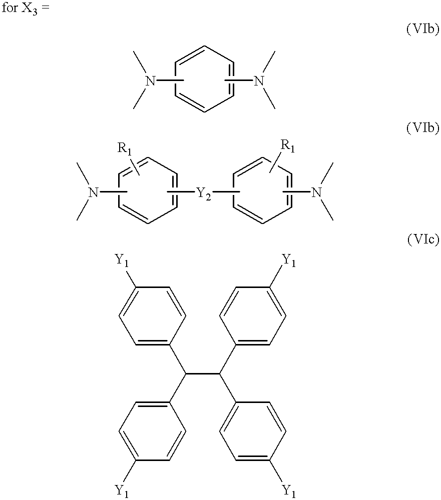

in which

Y₁ is a direct bond, —O—, —S— or —C(O)O—,

Y₂ is a direct bond, —SO₂—, —CO—, —S—, —SO—, CH₂—, —C(CH₃)₂— or —C(CF₃)₂—, and

n is 1-10.

The aromatic rings are unsubstituted or substituted one or more times by alkyl, aryl, alkoxy, aryloxy or halogen, as described in more detail above.

Particular preference as component b) is given to the compounds

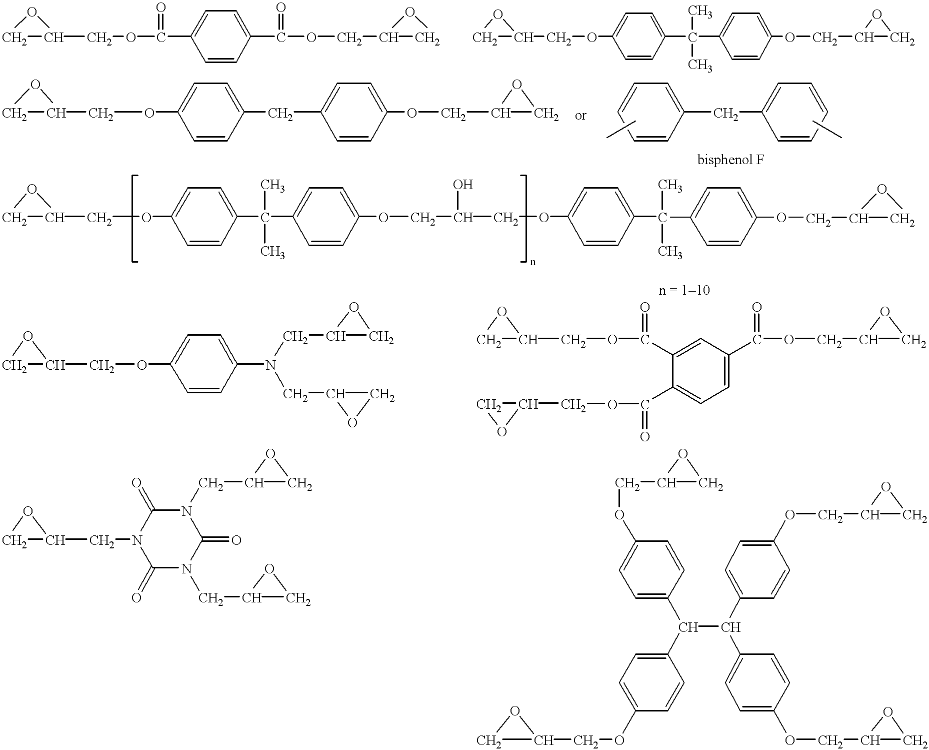

The granules of the invention can be added in practice to all polymers that are to be stabilized. Examples of these are:

1. Polymers of monoolefins and diolefins, for example polypropylene, polyisobutylene, polybut-1-ene, poly-4-methylpent-1-ene, polyisoprene or polybutadiene, as well as polymers of cycloolefins, for example of cyclopentene or norbornene; furthermore polyethylene (which optionally can be crosslinked), for example high-density polyethylene (HDPE), high-density and high molecular weight polyethylene (HDPE-HMW), high-density and ultrahigh molecular weight polyethylene (HDPE-UHMW), medium-density polyethylene (MDPE), low-density polyethylene (LDPE), linear low-density polyethylene (LLDPE) and branched low-density polyethylene (BLDPE).

Polyolefins, i.e. polymers of monoolefins exemplified in the preceding paragraph, in particular polyethylene and polypropylene, can be prepared by different, and especially by the following, methods:

a) radical polymerization (normally under high pressure and at high temperature)

b) catalytic polymerization using a catalyst that normally contains one or more metals of group IVb, Vb, VIb or VIII. These metals usually have one or more ligands, such as oxides, halides, alcoholates, esters, ethers, amines, alkyls, alkenyls and/or aryls that may be either π- or σ-coordinated. These metal complexes may be in the free form or fixed on carriers, for example on activated magnesium chloride, titanium(III) chloride, alumina or silicon oxide. These catalysts may be soluble or insoluble in the polymerization medium. The catalysts can be active as such in the polymerization or further activators may be used, for example metal alkyls, metal hydrides, metal alkyl halides, metal alkyl oxides or metal alkyloxanes, the metals being elements of groups Ia, IIa and/or IIIa. The activators may be modified, for example, with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE, LDPE/LLDPE).

3. Copolymers of monoolefins and diolefins with each other or with other vinyl monomers, for example ethylene-propylene copolymers, linear low density polyethylene (LLDPE) and mixtures thereof with low density polyethylene (LDPE), propylene-but-1-ene copolymers, propylene-isobutylene copolymers, ethylene-but-i-ene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and their copolymers with carbon monoxide or ethylene-acrylic acid copolymers and their salts (ionomers) as well as terpolymers of ethylene with propylene and a diene such as hexadiene, dicyclopentadiene or ethylidene-norbornene; and also mixtures of such copolymers with one another and with polymers mentioned under 1), for example polypropylene-ethylene-propylene copolymers, LDPE-ethylene-vinyl acetate copolymers, LDPE-ethylene-acrylic acid copolymers, LLDPE-ethylene-vinyl acetate copolymers, LLDPE-ethylene-acrylic acid copolymers and alternating or random polyalkylene-carbon monoxide copolymers and mixtures thereof with other polymers, for example polyamides.

4. Hydrocarbon resins (for example C₅-C₉) including hydrogenated modifications thereof (e.g. tackifier resins) and mixtures of polyalkylenes and starch.

5. Polystyrene, poly(p-methylstyrene), poly(α-methylstyrene).

6. Copolymers of styrene or α-methylstyrene with dienes or acrylic derivatives, for example styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methyl acrylate; mixtures of high impact strength of styrene copolymers and another polymer, for example a polyacrylate, a diene polymer or an ethylene-propylene-diene terpolymer, and block copolymers of styrene such as styrene-butadiene-styrene, styrene-isoprene-styrene, styrene-ethylene-butylene-styrene or styrene-ethylene-propylene-styrene.

7. Graft copolymers of styrene or a-methylstyrene, for example styrene on polybutadiene, styrene on polybutadiene-styrene or polybutadiene-acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene, styrene and alkyl acrylates or alkyl methacrylates on polybutadiene, styrene and acrylonitrile on ethylene-propylene-diene terpolymers, styrene and acrylonitrile on polyalkyl acrylates or polyalkyl methacrylates, styrene and acrylonitrile on acrylate-butadiene copolymers, as well as mixtures thereof with the copolymers mentioned under 6), for example the copolymer mixtures known as ABS, MBS, ASA or AES polymers.

8. Halogen-containing polymers such as polychloroprene, chlorinated rubber, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride; as well as copolymers thereof such as vinyl chloride-vinylidene chloride, vinyl chloride-vinyl acetate or vinylidene chloride-vinyl acetate.

9. Polymers derived from α,β-unsaturated acids and derivatives thereof such as polyacrylates and polymethacrylates, polymethyl methacrylates, impact-modified with butyl acrylate, polyacrylamides and polyacrylonitriles.

10. Copolymers of the monomers mentioned under 9) with each other or with other unsaturated monomers, for example acrylonitrile-butadiene copolymers, acrylonitrile-alkyl acrylate copolymers, acrylonitrile-alkoxyalkyl acrylate copolymers, acrylonitrile-vinyl halide copolymers or acrylonitrile-alkyl methacrylate-butadiene terpolymers.

11. Polymers derived from unsaturated alcohols and amines or the acyl derivatives or acetals thereof, such as polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in section 1.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain comonomers, for example ethylene oxide; polyacetals modified with thermoplastic polyurethanes, acrylates or MBS.

14. Polyphenylene oxides and sulfides, and mixtures thereof with styrene polymers or polyamides.

15. Polyurethanes derived from hydroxyl-terminated polyethers, polyesters and polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, such as polyamide 4, 6, 6/6, 6/10, 6/9, 6/12, 4/6, 12/12,11 and 12, aromatic polyamides starting from m-xylene, diamine and adipic acid; polyamides prepared from hexamethylenediamine and isophthalic and/or terephthalic acid and with or without an elastomer as modifier, for example poly-2,4,4-trimethylhexamethylene terephthalamide or poly-m-phenylene isophthalamide. Block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol. Also, polyamides or copolyamides modified with EPDM or ABS; and polyamides condensed during processing (RIM polyamide systems).

17. Polyureas, polyimides, polyamide-imides, polyether imides, polyester imides, polyhydantoins and polybenzimidazoles.

18. Polyesters derived from dicarboxylic acids and dialcohols and/or from hydroxycarboxylic acids or the corresponding lactones, such as polyethylene terephthalate, polybutylene terephthalate, polytrimethylene terephthalate, poly-1,4-dimethylolcyclohexane terephthalate, polyhydroxybenzoates, as well as block polyether esters derived from hydroxyl-terminated polyethers; polyethylene naphthylate, copolyesters of terephthalic acid, isophthalic acid, naphthalenedicarboxylic acid with ethylene glycol and/or cyclohexanedimethanol; and also polyesters modified with polycarbonates or MBS.

19. Polycarbonates and polyester carbonates.

20. Polysulfones, polyether sulfones and polyether ketones.

21. Crosslinked polymers derived from aldehydes on the one hand and phenols, urea or melamine on the other hand, such as phenol-formaldehyde resins, urea-formaldehyde resins and melamine-formaldehyde resins.

22. Drying and non-drying alkyd resins.

23. Unsaturated polyester resins derived from copolyesters of saturated and unsaturated dicarboxylic acids with polyhydric alcohols and also vinyl compounds as crosslinking agents, and also halogen-containing modifications thereof of low flammability.

24. Crosslinkable acrylic resins derived from substituted acrylates, for example from epoxy acrylates, urethane acrylates or polyester acrylates.

25. Alkyd resins, polyester resins and acrylate resins crosslinked with melamine resins, urea resins, isocyanates, isocyanurates, polyisocyanates or epoxy resins.

26. Crosslinked epoxy resins derived from aliphatic, cycloaliphatic, heterocyclic or aromatic glycidyl compounds, for example products of bisphenol A diglycidyl ethers, bisphenol F diglycidyl ethers, which are crosslinked by means of customary curing agents such as anhydrides or amines, with or without accelerators.

27. Natural polymers such as cellulose, natural rubber, gelatin and derivatives thereof which have been chemically modified in a polymer-homologous manner, for example cellulose acetates, cellulose propionates and cellulose butyrates, or the cellulose ethers such as methyl cellulose; as well as rosins and derivatives.

28. Blends (polyblends) of the aforementioned polymers, for example PP/EPDM, poly-amide/EPDM or ABS, PVC/EVA, PVC/ABS, PVC/MBS, PC/ABS, PBTP/ABS, PC/ASA, PC/PET, PC/PBT, PVC/CPE, PVC/acrylates, POM/thermoplastic PU, PC/thermoplastic PU, POM/acrylate, POM/MBS, PPO/HIPS, PPO/PA 6.6 and copolymers, PA/HDPE, PA/PP, PA/PPO, PBT/PC/ABS or PBT/PET/PC.

Preferred polymers are polyolefins, especially polypropylene and polyethylene in its various modifications.

The present invention additionally provides granules obtainable by the process of the invention, and for the use of the granules for stabilizing organic polymers, especially polyethylene or polypropylene.

The invention also provides an organic polymer comprising granules of the invention.

The examples which follow elucidate the invention.

### A) PREPARING STABILIZER BLENDS BY EXTRUSION

### EXAMPLE A1

Araldit GT 7072 (70 parts) and Irganox 1222 (30 parts) are introduced from 2 gravimetric weigh feeders at a throughput of 70 kg/h into a Buss co-kneader (Buss 70). The following extruder parameters are set at the beginning of the experiment:

Temperature profile:

Section 1: 50° C.

Section 2: 60° C.

Discharge screw: 60° C.

Screw shank: 50° C.

Die head: 120° C.

Rotary speed

Kneader: 65 rpm

Discharge screw: 60 rpm

Hot-cut pelletizer: 500 rpm

In the mixing section of the co-kneader the stabilizers are plastified and homogeneously dispersed. The melt is subsequently compacted in the discharge screw, pressed through a die plate comprising 20 die perforations (diameter 2.5 mm) and chopped into cylindrical granules with the hot-cut pelletizer. At the chopping stage, the melt is additionally cooled with an air/water mixture. After the chopping stage, the granules are first subjected to preliminary dewatering and then dried in a fluidized-bed dryer and cooled to room temperature.

The granules have a uniform product morphology, are dust-free and are stable on storage (>3 months). A powder mixture of identical raw materials (same composition) forms lumps after just a short storage period (<4 weeks).

### EXAMPLE A12

Araldit GT 7072 (70 parts) and a powder mixture composed of the raw materials Irganox 1010 (7.5 parts), Irgafos 168 (7.5 parts), calcium stearate (3 parts) and calcium oxide (12 parts) are introduced from 2 gravimetric weigh feeders at a throughput of 30 kg/h into a Buss co-kneader (Buss 70). The following extruder parameters are set at the beginning of the experiment:

Temperature profile:

Section 1: 60° C.

Section 2: 70° C.

Discharge screw: 70° C.

Screw shank: 60° C.

Die head: 90° C.

Rotary speed

Kneader: 360 rpm

Discharge screw: 95 rpm

Hot-cut pelletizer: 100 rpm

In the mixing section of the co-kneader the stabilizers are plastified and homogeneously dispersed. Not all of the components are melted. The melt is subsequently compacted in the discharge screw, pressed through a die plate comprising 20 die perforations (diameter 2.5 mm) and chopped into cylindrical granules with the hot-cut pelletizer. At the chopping stage, the melt is additionally cooled with an air/water mixture. After the chopping stage, the granules are first subjected to preliminary dewatering and then dried in a fluidized-bed dryer and cooled to room temperature.

The granules have a uniform product morphology, are dust-free and are stable on storage.

### B) USE EXAMPLES

### EXAMPLE B1: Pressure Storage Test

The granules prepared in accordance with Example A2 are stored in a glass beaker for 3 days in an oven at 40° C. During this time, the granules are subjected to the action of an 800 g weight. On removal from the oven, the granules can be shaken out of the glass beaker onto a metal plate. Agglomerated particles of granule can easily be broken down by a spatula.

### EXAMPLE B2: Testing Granule Quality by Hot Storage

Stabilizer blends of various composition are prepared in accordance with Examples A1 and A2. Depending on the raw materials employed (epoxide, stabilizer) or proportions in the case of identical raw materials, either all or only some of the material is melted in the extruder. Furthermore, as a function of the raw material employed, the melt is cooled at the chopping stage with air, with an air/water mixture or else with water alone.

The granules are tested as described below:

50 g of a mixture are distributed uniformly over the base of an aluminium tray. The tray is then stored in an oven for 24 h at the respective test temperature. After the end of the test, the contents of the tray are shaken out onto a metal plate. The tendency of the granules to stick is classified as follows:

1=falls apart by tapping

2=easily broken down by spatula

3=has tabletted, can be broken down by force

4=has sintered together

The results are shown in Tables 1 and 2.

TABLE 1

| Seri- | | | | | |
|---|---|---|---|---|---|
| al | Composition | Preparation | 24 h hot storage at | | |
| No. | Stabilizers | technique | 30° C. | 40° C. | 50° C. |
| B3 | Irganox | Extrusion | 1 | 2 | 3 |
| | 1222:Araldit GT 6071 | | | | |
| | 33 parts:67 parts | | | | |
| B4 | Irganox | Extrusion | 1 | 1-2 | 3 |
| | 1222:Araldit GT 7072 | | | | |
| | 30 parts:70 parts | | | | |
| B5 | Irganox | Extrusion | 1 | 1 | 2 |
| | 1425:Araldit GT 7072 | | | | |
| | 20 parts:80 parts | | | | |
| B6 | Irganox | Extrusion | 1 | 1 | 2 |
| | 1222:Araldit GT 7072 | | | | |
| | 30 parts:70 parts | | | | |

Comparative examples

| | | | | | |
|---|---|---|---|---|---|
| Co 1 | Irganox | Compacting | 2 | 2 | 3 |
| | 1222:Araldit GT 6071 | | | | |
| | 33 parts:67 parts | | | | |
| Co 2 | Irganox | Powder | 2 | 2 | 3 |
| | 1222:Araldit GT 6071 | mixture | | | |
| | 33 parts:67 parts | | | | |

TABLE 2
Storage stability of additive granules prepared
in accordance with the invention

| Serial | | | 24 h hot storage at |
|---|---|---|---|
| No. | Stabilizer composition | | 30° C. |
| B7 | 50 | parts of Araldit GT 7072 | 1 |
| | 10 | parts of calcium stearate | |
| | 10 | parts of Irgafos 168 | |
| | 5 | parts of Igranox 1010 | |
| | 12.5 | parts of Chimassorb 944 | |
| | 12.5 | parts of Tinuvin 622 | |
| B8 | 70 | parts of Araldit GT 7072 | 1 |
| | 10 | parts of Tinuvin 326 | |
| | 10 | parts of Chimassorb 944 | |
| | 10 | parts of Tinuvin 622 | |
| B9 | 70 | parts of Araldit GT 7072 | 1 |
| | 10 | parts of Chimassorb 81 | |
| | 10 | parts of Chimassorb 944 | |
| | 10 | parts of Tinuvin 622 | |
| B10 | 70 | parts of Araldit GT 7072 | 1 |
| | 15 | parts pf DHT 4A (hydrotalcite) | |
| | 5 | parts of Irganox 1010 | |
| | 10 | parts of Irgafos 168 | |
| B11 | 70 | parts of Araldit GT 7072 | 1 |
| | 15 | parts of Irganox PS802 | |
| | 5 | parts of Irganox 1010 | |
| | 10 | parts of Irgafos 168 | |
| B12 | 63 | parts of Araldit GT 7072 | 1 |
| | 10.8 | parts of CaO | |
| | 2.7 | parts of calcium stearate | |
| | 6.75 | parts of Irganox 1010 | |
| | 6.75 | parts of Igrafos 168 | |
| | 10 | PE 520 (polyethylene wax) | |
| B13 | 70 | parts by Araldit GT 7072 | 1 |
| | 12 | parts of calcium stearate | |
| | 12 | parts of Irgafos 168 | |
| | 6 | parts of Irganox 1076 | |

Tendency to stick
1 = falls apart by tapping

### C) OVEN AGEING EXAMPLES

The effectiveness of the dust-free, epoxy-containing stabilizer granules is investigated by incorporating them into PP/EPDM (part-painted waste material) and then carrying out testing.

The ingredients indicated in Table 3 are processed to form granules in accordance with Example A2 or, in the case of the comparative test, are mixed in powder form and incorporated into the polymer (PP/EPDM waste material) with the aid of a co-rotating twin-screw extruder at max. 260° C. and 100 rpm. The melt is filtered using a 200 μm screen assembly and then granulated.

The polymer granules are injection moulded at max. 240° C. to give test specimens.

The test specimens are aged in a convection drying oven at 135° C. (Table 3) or at 150° C. (Table 4).

Ageing is monitored via the tensile impact strength (Table 3) in accordance with DIN 53448 or is determined by a flexural test to the point of fracture (Table 4).

TABLE 3
Oven ageing at 135° C.

| | | Tensile impact strength after | | | | |
|---|---|---|---|---|---|---|
| | | | | 1000 | 1250 | 1500 |
| | | 0 h | 750 h | h | h | h |
| | Stabilization | [kJ/m²] | | | | |
| Com- | no additive | 379 | 221 | 219 | 90 | 71 |
| pari- | | | | | | |
| son 1 | | | | | | |
| Com- | mixture: | 375 | 393 | 260 | 259 | 214 |
| pari- | 0.3500% of solid bisphenol | | | | | |
| son 2 | A diglycidyl ether, | | | | | |
| | Araldit GT 7072 | | | | | |
| | compacted stabilizer | | | | | |
| | mixture | | | | | |
| | 0.0600% CaO | | | | | |
| | 0.0150% calcium stearate | | | | | |
| | 0.0375% Irganox 1010 | | | | | |
| | 0.0375% Irgafos 168 | | | | | |
| Ex- | Stabilizer granules: | 414 | 401 | 337 | 314 | 286 |
| ample | 0.3500% of solid bisphenol | | | | | |
| C1 | A diglycidyl ether, | | | | | |
| | Araldit GT 7072 | | | | | |
| | 0.0600% CaO | | | | | |
| | 0.0150% calcium stearate | | | | | |
| | 0.0375% Irganox 1010 | | | | | |
| | 0.0375% Irgafos 168 | | | | | |

TABLE 4
Oven ageing at 150° C.

| | | Time to fracture |
|---|---|---|
| | Stabilization | [days] |
| Comparison | no additive | 11 |
| 3 | | |
| Comparison | mixture: | 14 |
| 4 | 0.3500% of solid bisphenol A | |
| | diglycidyl ether, Araldit GT 7072 | |
| | compacted stabilizer mixture | |
| | 0.0600% CaO | |
| | 0.0150% calcium stearate | |
| | 0.0375% Irganox 1010 | |
| | 0.0375% Irgafos 168 | |
| Example C2 | Stabilizer granules: | 15 |
| | 0.3500% of solid bisphenol A | |
| | diglycidyl ether, Araldit GT 7072 | |
| | 0.0600% CaO | |
| | 0.0150% calcium stearate | |
| | 0.0375% Irganox 1010 | |
| | 0.0375% Irgafos 168 | |

The examples in Tables 3 and 4 show that the stabilizer granules have a good stabilizing effect. The properties of the material are maintained at a higher level for a longer time.

Surprisingly, better values are achieved than in the case of the physical mixture of customary, commerical solid bisphenol A diglycidyl ether and compacted stabilizer mixture (Comparative experiments 1-4).

### Additives Used

Araldit GT 6071: bisphenol A diglycidyl ether, epoxy number (Aeq./kg) 2.15-2.22, softening point 70-75° C.

Araldit GT 7072: bisphenol A diglycidyl ether, epoxy number (Aeq./kg) 1.68-1.75, softening point 82-90° C.

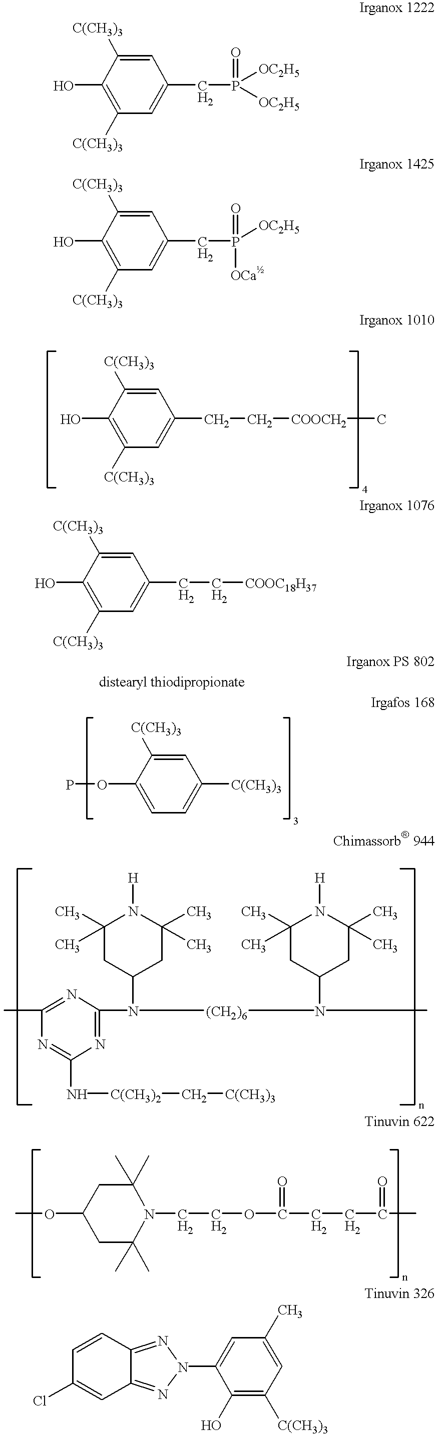

The products employed are commercial products and the names are registered trade marks of CIBA Spezialitätenchemie AG

What is claimed is:

1. Low-dust granules of plastics additives, comprising
a) a phenolic antioxidant, an organic phosphite or phosphonite, a phosphonate, a sterically hindered amine or a UV absorber, individually, or a mixture of these compounds, and
b) at least one epoxy compound which is solid at room temperature.

2. Granules according to claim 1, which comprise a polyfunctional epoxide as component b).

3. Granules according to claim 1, which comprise 10-90% by weight of an epoxy compound.

4. Granules according to claim 1, which have a particle size distribution of between 1 mm and 6 mm as defined in accordance with ISO 3435.

5. Granules according to claim 1, which have a loose bulk density of greater than 500 g/l.

6. Granules according to claim 1, which have a free flow in accordance with DIN 53492 of less than 15 s (tR15).

7. Granules according to claim 1, which have a fine fraction as determined by the Heubach test of not more than 0.1% by weight.

8. Granules according to claim 1, which comprise further plastics additives from the group of the hydrotalcites, metal oxides, metal carbonates, metal soaps, antistats, antiblocking agents, flame retardants, thioesters, internal and external lubricants, processing aids and pigments.

9. Granules according to claim 1, which consist of 30-80% by weight of epoxy compound, 5-25% by weight of an antioxidant of the sterically hindered phenol type, 5-25% by weight of a phosphite or phosphonite, 10-40% by weight of CaO and 1-5% by weight of calcium stearate.

10. Granules according to claim 1, which consist of 50-80% by weight of epoxy compound and of 50-20% by weight of a phosphonate.

11. Granules according to claim 1, which comprise as phenolic antioxidant 3,5,3′,5′-tetra-tert-butyl-4,4′-dihydroxydibenzyl ether, octadecyl 4-hydroxy-3,5-dimethylbenzylmercaptoacetate, tris(3,5-di-tert-butyl-4-hydroxybenzyl)-amine, bis(4-tert-butyl-3-hydroxy-2,6-dimethylbenzyl) dithioterephthalate, bis(3,5-di-tert-butyl-4-hydroxybenzyl) sulfide, isooctyl 3,5-di-tert-butyl-4-hydroxybenzylmercaptoacetate, 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol;
2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl) isocyanurate;
4-hydroxylauranilide, 4-hydroxystearanilide, octyl N-(3,5-di-tert-butyl-4-hydroxyphenyl)carbamate;
or an ester of β-(3,5-di-tert-butyl-4-hydroxyphenyl)propionic acid with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane or 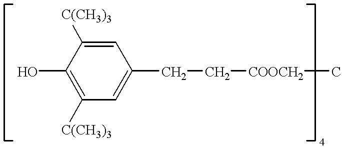
β-(3,5-di-tert-butyl-4-hydroxyphenyl)propionic ester of pentaerythritol 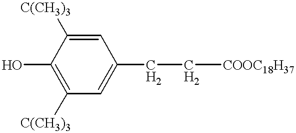
octadecyl β-(3,5-di-tert-butyl-4-hydroxyphenyl)propionate 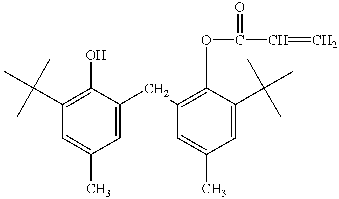
2-(1,1-dimethylethyl)-6-[[3-(1,1-dimethylethyl)-2-hydroxy-5-methylphenyl]methyl]-4-methylphenyl 2-propenoate; 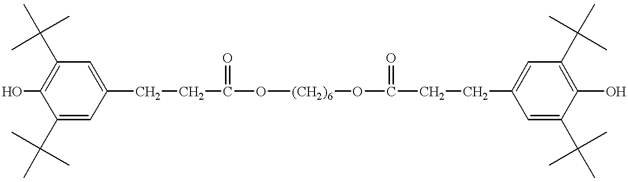
1,6-hexanediyl 3,5-bis(1,1-dimethylethyl)-4-hydroxyphenylpropanoate; 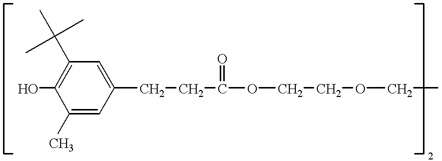
1,2-ethanediylbis(oxy-2,1-ethanediyl)3-(1,1-dimethylethyl)-4-hydroxy-5-methyl-phenylpropanoate; 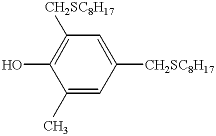
{2-methyl-4,6-bis[(octylthio)methyl]phenol}; 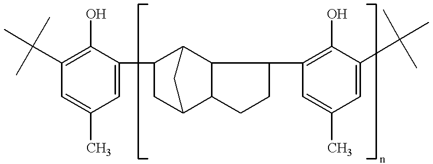
butylated reaction product of para-cresol and dicyclopentadiene (average molecular weight 600-700) 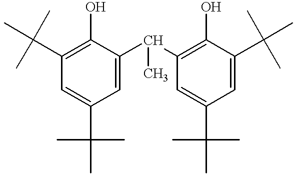
2,2′-ethylidene-bis-(4,6-di-tert-butylphenol); 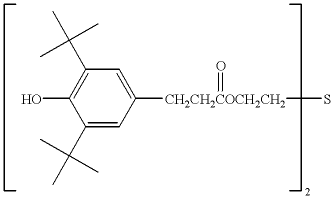
thiodi-2,1-ethanediyl 3,5-bis(1,1-dimethylethyl)-4-hydroxyphenylpropanoate; 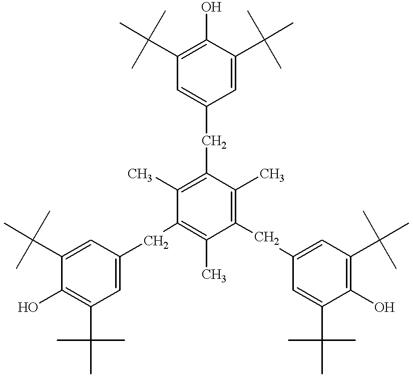
4,4′,4″-[(2,4,6-trimethyl-1,3,5-phenyltriyl)tris (methylene)]tris[2,6-bis(1,1-dimethylethyl)-phenol]; 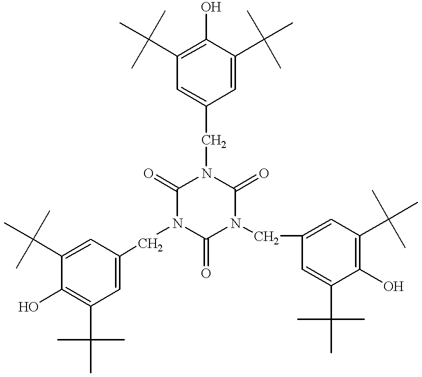
1,3,5-tris[[3,5-bis(1,1-dimethylethyl)-4-hydroxyphenyl]methyl]-1,3,5-triazine-2,4,6(1H,3H,5H)-trione.

12. Granules according to claim 1, which comprise as phosphonate dimethyl 2,5-di-tert-butyl-4-hydroxybenzyl-phosphonate, diethyl 3,5-di-tert-butyl-4-hydroxybenzylphosphonate, dioctadecyl 3,5-di-tert-butyl-4-hydroxybenzylphosphonate, dioctadecyl-5-tert-butyl-4-hydroxy-3-methylbenzyl-phosphonate and the calcium salt of 3,5-di-tert-butyl-4-hydroxybenzylphosphonic acid monoethyl ester.

13. Granules according to claim 1, which comprise as phosphites or phosphonites triphenyl phosphite, diphenyl alkyl phosphites, phenyl dialkyl phosphites, tris(diphenylalkylphosphito)amines, tris(nonylphenyl) phosphite, trilauryl phosphite, trioctadecyl phosphite, distearyl pentaerythrityl diphosphite, tris(2,4-di-tert-butylphenyl) phosphite, bis(2,4-di-tert-butylphenyl) pentaerythrityl diphosphite, tristearyl sorbityl tri-phosphite, tetrakis(2,4-di-tert-butylphenyl) 4,4′-biphenylenediphosphonite, 3,9-bis(2,4-di-tert-butyl-4-methylphenoxy)-2,4,8,10-tetraoxa-3,9-diphosphaspiro[5.5]undecane, 3,9-tris(2,4,6-tris-tert-butylphenoxy)-2,4,8,10-tetraoxa-3,9-diphosphaspiro[5.5]undecane, 2,4,6-tris-tert-butylphenyl 2-butyl-2-ethyl-1,3-propanediyl phosphite and 2,2′-ethylidenebis(4,6-di-tert-butylphenyl) fluorophosphite.

14. Granules according to claim 1, which comprise as additional additive an oxide of metals of the second main group or sub group.

15. Granules according to claim 1, which comprise as epoxy compound an epoxide selected from the group consisting of

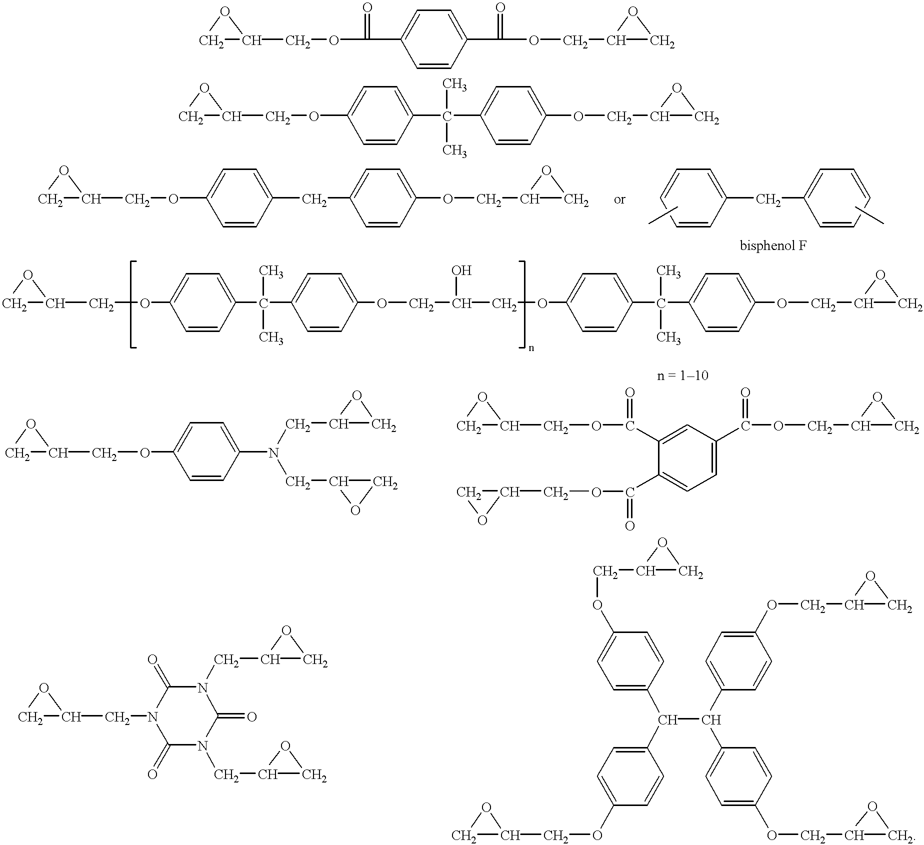

16. A process for preparing plastics additive granules, which comprises heating
a) a phenolic antioxidant, an organic phosphite or phosphonite, a phosphonate, a sterically hindered amine or a UV absorber, individually, or a mixture of these compounds, and
b) at least one polyfunctional epoxy compound which is solid at room temperature to an extent such that at least 80% by weight of the epoxy compound has melted, pressing the melt through a plate provided with dies or perforations, the die or perforation diameter being between 1 and 10 mm, and chopping the resulting strands in the plastic state to form granules.

17. A process according to claim 16, wherein the temperature before the outlet die (at the die head) is between 60-160° C.

18. Granules obtainable by a process according to claim 16.

19. The use of granules according to claim 1 for stabilizing organic polymers.

20. An organic polymer comprising granules according to claim 1.
